(19) United States
(12) Patent Application Publication
(10) Pub. No.: US 2012/0109940 A1
(43) Pub. Date: May 3, 2012

(54) INFORMATION PROCESSING SYSTEM, METHOD OF CONTROLLING INFORMATION PROCESSING SYSTEM, AND SEARCH CONTROLLER

(75) Inventors: Yohsuke ISHII, Yokohama (JP); Takaki NAKAMURA, Ebina (JP); Hitoshi KAMEI, Sagamihara (JP)

(73) Assignee: Hitachi Solutions, Ltd.

(21) Appl. No.: 13/046,299

(22) Filed: Mar. 11, 2011

(30) Foreign Application Priority Data
Oct. 27, 2010 (JP) 2010-241276

(51) Int. Cl. G06F 17/30

(52) U.S. Cl. 707/722; 707/E17.005; 707/E17.014

(57) ABSTRACT

An integrated search process on files can be executed by multiple search devices even if setting granularities of access control to the files are different among the search devices. Upon execution of file migration or access control information batch update, information needed for a search server to execute security trimming is extracted from ACL information in a specific format on a document management server. Then the extracted information is transferred to the search server, converted to ACL information in a general format, and registered in a search index in the search server. With this process, a storage system using different access control methods is configured to perform the security trimming based on the ACL information with which access control having the finest setting granularity can be set.

### CROSS REFERENCE TO RELATED APPLICATION

The present application claims priority upon Japanese Patent Application No. 2010-241276 filed on Oct. 27, 2010, which is herein incorporated by reference.

### BACKGROUND

1. Technical Field

The present invention relates to an information processing system, a method of controlling an information processing system, and a search controller. In particular, the invention relates to an information processing system, a method of controlling an information processing system, and a search controller, which provide a search result by integrating search results acquired by multiple search servers in response to a search request from a search user.

2. Related Art

In recent years, taking advantage of providing a higher performance and a lower cost of computers, computers have been widely used in various fields of business and use. Furthermore, there have been also widely application modes of providing, as a single computer system, an entire system configured including multiples computers with different characteristics hierarchically coupled to each other. For example, a high-priced computer capable of fast-access and a low-priced computer capable of storing a large volume of data are combined together, so that a user can be provided of a relatively inexpensive system capable of handling a large volume of data and allowing a fast-access to the data.

Under the above-described circumstances, however, recently there is a problem that the number of data files stored in a computer system becomes so enormous that a user has difficulty in finding a location where a desired file is stored and therefore cannot easily access the file. In order to solve this problem, a full-text search service has begun to be used. In this full-text search service, a search server analyzes file data stored in a computer system and creates a search index in advance. A user issues a search query for searching a file desired to be acquired to the search server and accesses the target file based on a search result. Such a search service is more likely to become a more important service for the user and to become more widely used because the number of data files stored in a computer system may further increase and it may become more difficult for users to know all locations of the stored data files.

Many search servers perform security trimming for a search result. The security trimming is a function to extract, from contents in a search result, only a content to which a user having given the search request has an access right and to provide such content as a search result. For example, if an access control list (hereinafter, “ACL”) is set for search target files as access control information, it is determined based on the ACL information whether or not a user has an access right to a target file. Then, based on the determination result, it is determined whether or not to include information of the target file in the search result. This function can prevent an unauthorized user from making an unauthorized access to the file through the search result.

Conventionally, if multiple search servers are present, a user has to separately make a search request to each of the search servers and separately acquire a result from each of the search servers. This means that issuance of a same search query to the multiple search servers needs to be performed as many times as the number of the multiple search servers, which is not convenient for a user. To solve this problem, an integrated search service has started to be used. The integrated search service allows a user to acquire an integrated search result from all multiple independent search servers by issuing a search query only once to the search servers. For example, the specification of OpenSearch for an integrated search process has been open to the public and begun to be used. In this integrated service, search servers are operated independently of each other, and the search severs are configured to accept a search request through a unified standard interface such as the above-described OpenSearch. In this way, an integrated search using multiple loosely-coupled search servers becomes possible. In the integrated search performed by the loosely-coupled multiple search servers, a search algorithm and search index update timing that are used are different among the search servers. In contrast, there is another mode of providing a tightly-coupled integrated search service by integrally operating multiple search servers. In the tightly-coupled integrated search service, the search servers use the same search algorithm and integrally perform search index update within a system. The following description of the present invention is based on the assumption that an integrated search service is provided in a loosely-coupled manner.

In the case of operating the above-described hierarchical computer system, the system dynamically changes a storage location of data file through a migration process between computers constituting the system in order to optimally allocate the data file within the system. If a unified access control method is applied to the computers constituting the system, migration of a data file does not cause any problem because the access control information before migration is continually applicable as the access control information of the target file. However, there is also a case where computers constituting the system use different access control methods to each other. For example, as for ACL for defining access control information, there are various variations such as POSIX ACL and NTFS ACL. In this case, if a data file is migrated within the system, the access control information of the target file has to be converted to information in a format applicable in a migration destination. US Patent Application Publication No. 2009/0077087 discloses a method of converting access control information, in particular, ACL information. This method can convert ACL information in some ACL format to ACL information in another format whose setting granularity (a detail degree of setting access control items) is finer. Even after a data file is migrated between computers using different access control methods, use of this method enabling ACL conversion allows access control of the target file in the migration destination to be performed based on information of the target file set before the migration.

### SUMMARY

However, the technique disclosed in US Patent Application Publication No. 2009/0077087 includes a problem that the technique is not based on consideration of ACL conversion to an ACL format having a coarse setting granularity, even though ACL conversion to an ACL format having a finer setting granularity is possible. The reason is that there is a possibility of missing part of ACL information in the process of attempting to convert an ACL format to an ACL format having a coarse setting granularity. When even a part of the ACL information is missing, it cannot be assured that a desired access control can be continuously performed. This may cause a significant security problem, such as an unauthorized access to a file.

In other words, under an environment in which a first computer handling ACL information in a general format and a second computer handling ACL information in a specific format whose setting granularity is finer than that of the general format are present as components of a computer system, the above-described problem becomes obvious when the whole computer system is provided as one file system image and access control is performed for data files in the system by using the ACL information in the specific format handled by the second computer. This is because, after file data is migrated from the second computer to the first computer in the system, the ACL information of the target file cannot be reconverted again.

In addition, if there are a first search server indexing data files on the first computer for search and a second search server indexing data files on the second computer for search, in many cases the first search server can interpret only the ACL information in the general format and the second search server can interpret only the ACL information in the specific format. In this case, if a data file on the second computer is migrated to the first computer, the first search server cannot interpret the ACL information of the migrated file. For this reason, if the file is included in a search result, the first search server cannot correctly perform the security trimming. Accordingly, there is required a technique that allows the search server to perform the security trimming on the search result even in the above-described case.

The invention is made in view of solving the above-described and other problems. Accordingly, an object of the invention is to provide an information processing system, a method of controlling an information processing system, and a search controller, which allow an integrated search on files to be performed by multiple search devices even if setting granularities of the access control to the files are different among the search devices.

According to an aspect of the invention, provided is an information processing system that provides a file storage region for an external apparatus. In the information processing system, a first storage apparatus is configured to control an access from the external apparatus to a stored file according to a first access control information format, a second storage apparatus is configured to control an access from the external apparatus to the stored file according to a second access control information format whose setting granularity is finer than that of the first access control information format used in the first storage apparatus, a first search controller is configured to search for the file stored in the first storage apparatus in response to a search request from the external apparatus and refine a search result by applying the first access control information format to the search result, and a second search controller is configured to search for the file stored in the second storage apparatus in response to a search request from the external apparatus and refine a search result by applying the second access control information format to the search result. The first storage apparatus, the second storage apparatus, the first search controller and the second search controller are coupled to one another. In the information processing system, the second search controller receives the search request from the external apparatus, transfers the received search request to the first search controller, and integrates the search result by the first search controller and the search result by the second search controller together. If the file stored in the second storage apparatus is migrated to the first storage apparatus, the first search controller extracts, from first access control information based on the second access control information format set for the file, information which the first search controller is to use when creating a search index based on the migrated file, converts the extracted information to second access control information based on the first access control information format, and sets the converted information as information on the file in a search index of the first search controller. The first search controller refines the search result based on the second access control information, when executing a search in response to the search request received from the second search controller.

### BRIEF DESCRIPTION OF THE DRAWINGS

For a more complete understanding of the present invention and the advantages thereof, reference is now made to the following description taken in conjunction with the accompanying drawings wherein:

FIG. 1 is a system configuration diagram of a document management system 1 according to an embodiment of the invention;

FIG. 2 is a flowchart showing an illustrated flow of a document file storage process performed by the document management system 1;

FIG. 3 is a flowchart showing an illustrated flow of a document file search process performed by the document management system 1;

FIG. 4 is a hardware configuration diagram of a document management server 1100;

FIG. 5 is a hardware configuration diagram of a search server 2100;

FIG. 6 is a hardware configuration diagram of a file server 3100.

FIG. 7 is a hardware configuration diagram of a client apparatus 4100;

FIG. 8 is a hardware configuration diagram of an authentication server 5100;

FIG. 9 is an illustration exemplifying system configuration components relating to a file management process and an integrated search process;

FIG. 10 is an illustration exemplifying a data structure of a file which is stored in the document management server 1100;

FIG. 11 is an illustration exemplifying a data structure of a file which is stored in the file server 3100;

FIG. 12 is an illustration exemplifying a search index management table 6100;

FIG. 13 is an illustration exemplifying a search index registration file management table 6200;

FIG. 14 is an illustration exemplifying an ACL conversion information management table 6300;

FIG. 15 is a flowchart showing an illustrated flow of a file migration process;

FIG. 16 is a flowchart showing an illustrated flow of an index update process;

FIG. 17 is a flowchart showing an illustrated flow of an integrated search request process;

FIG. 18 is a flowchart showing an illustrated flow of a file update process;

FIG. 19 is a hardware configuration diagram of a document management server 1100 according to a second embodiment;

FIG. 20 is a hardware configuration diagram of a search server 2100 according to the second embodiment;

FIG. 21 is an illustration exemplifying an ACL inheritance range management table 6400 according to the second embodiment;

FIG. 22 is an illustration exemplifying an ACL batch update content management table 6500 according to the second embodiment;

FIG. 23 is a flowchart showing an illustrated flow of an ACL batch update process according to the second embodiment;

FIG. 24 is a flowchart showing an illustrated flow of an ACL batch update notification reception process according to the second embodiment;

FIG. 25 is a flowchart showing an illustrated flow of an ACL conversion process according to a third embodiment;

FIG. 26 is a flowchart showing an illustrated flow of a migration file reception process according to a fourth embodiment; and

FIG. 27 is a flowchart showing an illustrated flow of a file migration process according to a fifth embodiment.

### DETAILED DESCRIPTION OF THE EMBODIMENTS

### First Embodiment

The present embodiment describes a method of performing security trimming when a search server performs an integrated search.

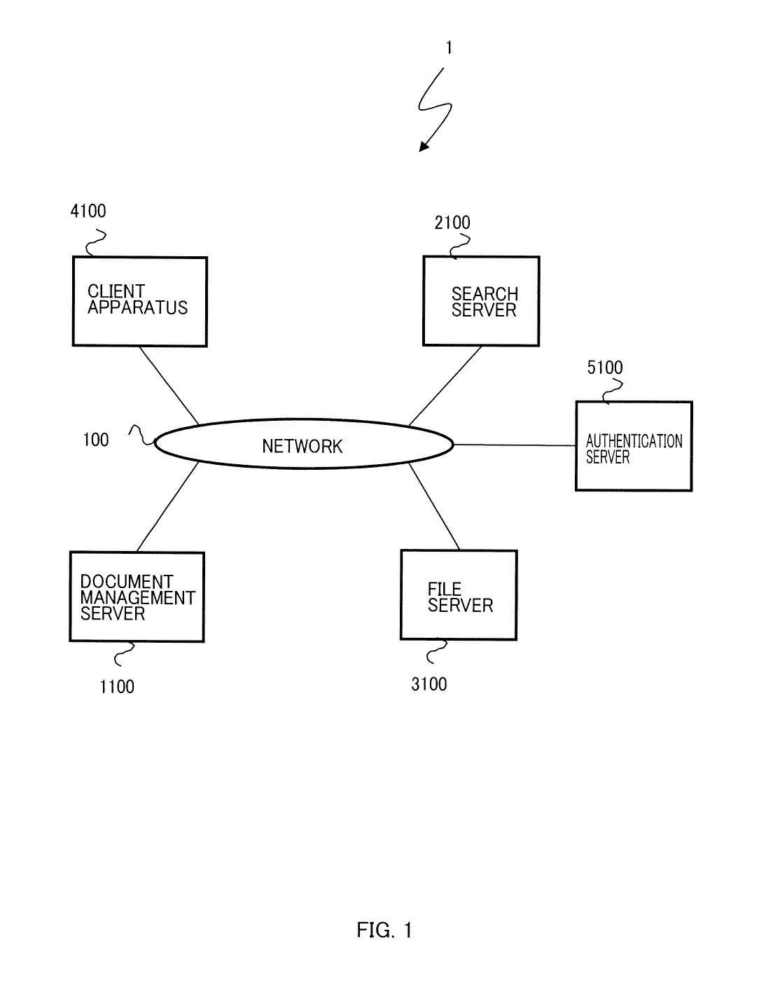

FIG. 1 is an illustration exemplifying the system configuration of a document management system 1 which is an information processing system implemented in a first embodiment of the invention. A document management server 1100 (a first search controller and a second storage apparatus), a search server 2100 (a second search controller), a file server 3100 (a first storage apparatus), a client apparatus 4100 (an external device), and an authentication server 5100 are coupled to one another via a network 100. The present system 1 provides services such as services for storing files to share in the document management server 1100 and services for searching the stored files.

The specific contents of the services are as follows. A user can access the document management server 1100 from the client apparatus 4100 and store a file of the user in the document management server 1100. The document management server 1100 creates a search index of the stored file. The user can give the document management server 1100 a designation of a condition, and thereby search for the stored file.

In addition one part of the files stored in the document management server 1100 can be migrated to an external file server 3100 for a case where a free storage space of the document management server 1100 gets tight. However, the user of the document management server 1100 does not know if each file is migrated to the file server 3100. It is adapted so that the user of the client apparatus 4100 can make an access in a same way to both files in the document management server 1100 and files migrated to the file server 3100 without recognizing a difference between the files.

As for the files migrated to the external file server 3100, the external search server 2100 creates an index for search and deletes the index of the file in the document management server 1100. When receiving a search request from the user, the document management server 1100 outputs a search request not only to the index thereof but also to the search server 2100 coupled via the network 100, and integrates the search results and provides an integrated result to the user.

The document management server 1100 or the search server 2100 creates a search result utilizing the index at the time of searching and refines (the security trimming) the search result, so that only information on the file to which the search user has a read privilege is included in the search result. This prevents a user without a read privilege from making an access to the file. A specific configuration for implementing the security trimming process is described later.

In FIG. 1, only one each of the components is shown but the present invention is not limited to this configuration. If possible, the system may be configured of a multiple of the components. Also, in FIG. 1, each component is shown as an individual device but the present invention is not limited to this configuration. If possible, any two or more components may be used to configure one device. Moreover, a connection mode of the network 100 may be any network mode, such as an internet connection or an intranet connection via a local area network (hereinafter “LAN”).

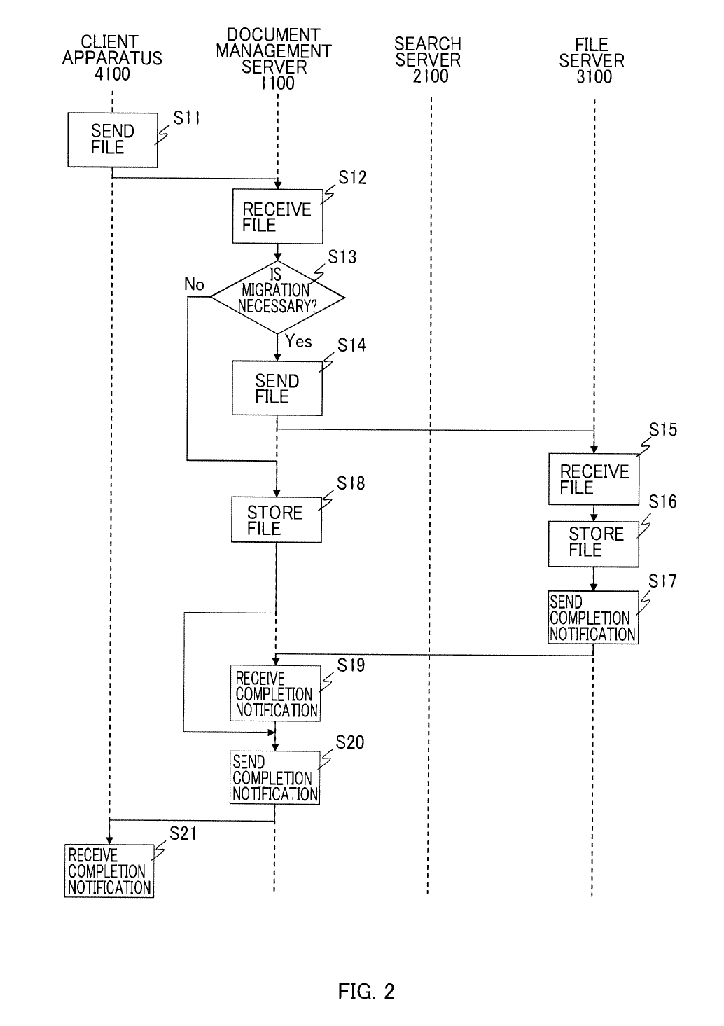

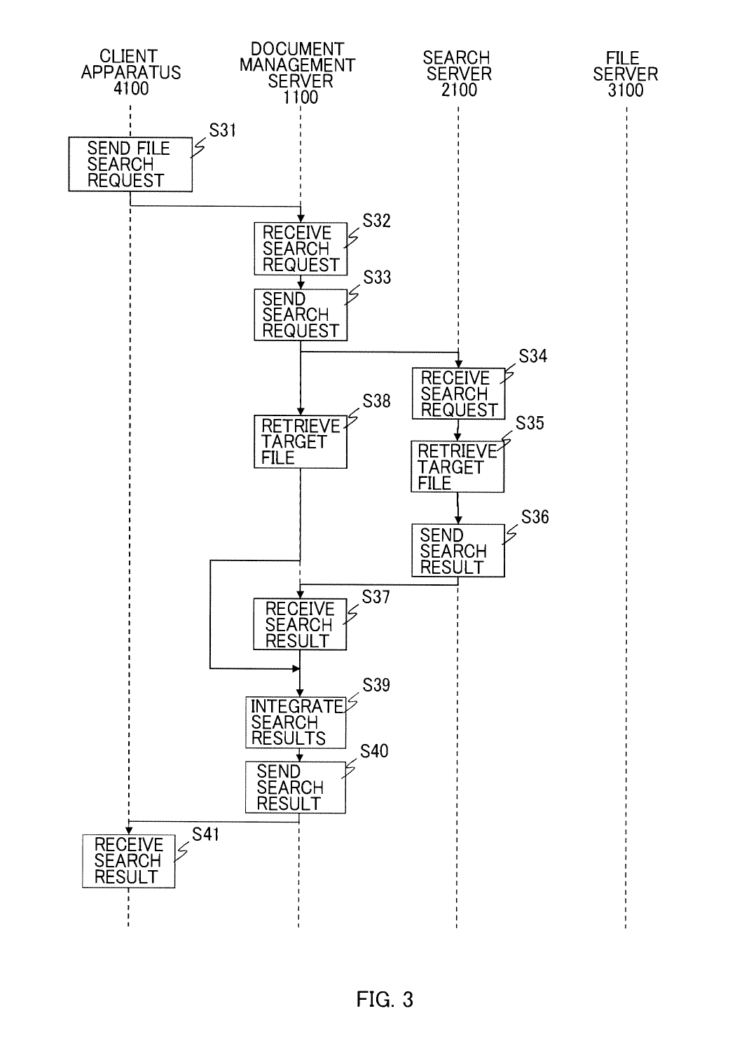

The description is given here of the illustrated flows of the process to store a document file and the process to search document files in the configuration of the document management system 1 according to the embodiment briefly described above. FIG. 2 shows an illustrated flow of the process to store a document file. FIG. 3 shows an illustrated flow of the process to search document files. Note that in each drawing, letter “S” which is given to reference signals showing processing steps means a “step” (the same is true in the following description and drawings).

Referring now to FIG. 2, in the process to store a document file, the client apparatus 4100 sends a document file to be stored in the document management server 1100 (S11). When having received the file, the document management server 1100 checks if there is free space in the storage device thereof and determines if migration needs to be executed (S12, S13). If it is determined that migration is needed (Yes at S13), the document management server 1100 sends the file which is selected as needed to the file server 3100 (S14). The file server 3100 receives the migration target file from the document management server 1100 and stores the file in the storage device (S15, S16) and sends a completion notification to the document management server 1100 (S17).

On the other hand, if the document management server 1100 which has received the file from the client apparatus 4100 determines that migration is not needed (No at S13), the document management server 1100 stores the file in the storage device thereof (S18). Note that the above-described timing of receiving a document file is just an example of the timing to determine whether or not migration is needed, and the embodiment is not limited to that timing.

When having received the completion notification from the file server 3100, the document management server 1100 sends a completion notification to the client apparatus 4100 (S19, S20) and then a series of processes is finished when the client apparatus 4100 receives the completion notification (S21). Even when migration is not executed, a completion notification is similarly sent to the client apparatus 4100 at step S20.

Referring now to FIG. 3, in the process to search document files, the client apparatus 4100 sends a file search request to the document management server 110 (S31). When having received the search request, the document management server 1100 refers to index information of files stored therein and sends a search request to the search server 2100 (S32, S33). When having received the search request (S34), the search server 2100 executes search of a target file utilizing the index which is managed in the search server 2100 (S35). Then, the search server 2100 sends a search result acquired at step S35 to the document management server 1100 (S36). The document management server 1100 receives the search result from this file server 3100 (S37).

On the other hand, the document management server 1100 executes search of the target file utilizing the index which is managed therein in response to the search request received from the client apparatus 4100 (S38).

After that, the document management server 1100 integrates the result of searching for the files stored therein with the result of searching for the files in the file server 3100 (S39) and sends an integrated search result to the client apparatus 4100 (S40). A series of processes is finished when the client apparatus 4100 receives the integrated search result (S41).

According to the above-described illustrated flows, the client apparatus 4100 issues a search request only once to the document management server 1100, so that a target file which is stored somewhere in the whole system 1 can be searched out. Based on the illustrated general configuration of the system 1 and the brief description of the processes, each of the components of the system 1 and effects thereof are described below in detail.

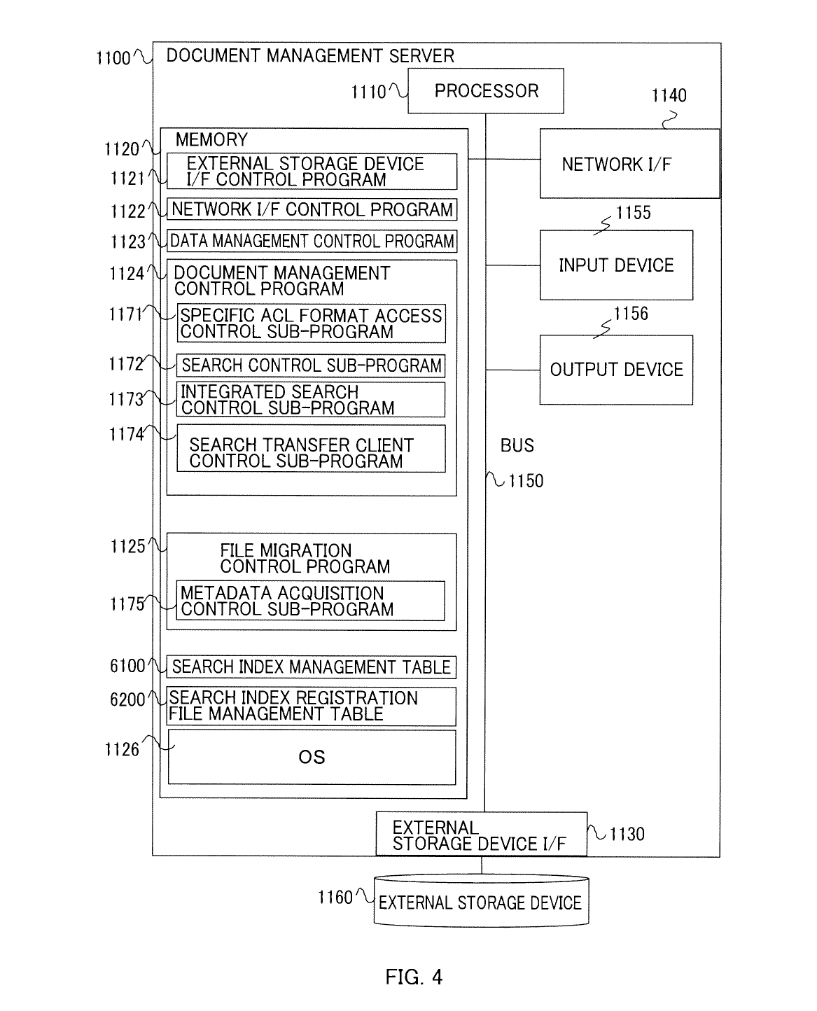

FIG. 4 is an illustration exemplifying the hardware configuration of the document management server 1100. The document management server 1100 is configured of a CPU (Central Processing Unit) to execute programs to be described later, a processor 1110 such as an MPU (Micro-Processing Unit), a memory 1120 such as RAM (Random Access Memory) to temporarily store programs and data, an external storage device I/F 1130 to access an external storage device 1160 such as a hard disk drive (“HDD”) or a semiconductor storage drive (Solid State Drive, “SDD”), a network I/F 1140 to access other devices coupled via a network, and a bus 1150 to connect among these components. The external storage device I/F 1130 includes, for example, an interface circuit between the external storage device 1160 and the bus 1150 and a processor for data processing. The network I/F 1140 is configured as NIC (Network Interface Card) or HBA (Host Bus Adaptor) including an interface circuit between the external network and the bus 1150 and a processor for data processing, for example.

The document management server 1100 also includes an input device 1155 and an output device 1156. The input device 1155 is a user interface device for data input, for example, such as a keyboard, a mouse, a touch panel, or a pen tablet. The output device 1156 is, for example, a display such as a liquid crystal monitor or an output device such as a printer.

The memory 1120 stores an external storage device I/F control program 1121 which is a program for controlling the external storage device I/F 1130, a network I/F control program 1122 which is a program for controlling the network I/F 1140, a data management control program 1123 for providing a file system or database which is to be used for managing stored data in the document management server 1100, a document management control program 1124 for providing a document management service in the document management server 1100, a file migration control program 1125 for providing a file migration service in the document management server 1100, a search index management table 6100 and a search index registration file management table 6200 which are used by the document management control program 1124. These programs are executed by the processor 1110 to achieve a predetermined function of each program. In general, these programs are stored in the external storage device 1160 and read to the memory 1120 and executed by the processor 1110. However, it is also possible that a non-volatile memory such as ROM (Read Only Memory) is provided in the memory 1120 and these programs are stored therein. Such change in the configuration may be also applied to the search server 2100, file server 3100, and client apparatus 4100 to be described below.

In addition, in the document management server 1100, an operation system 1126 (OS) for providing a base of each program to be executed on the memory 1120 is operated. The OS 1126 includes, as an example, such as Windows (registered trademark), Linux (registered trademark), but it is not limited thereto and any system may be operated according to a system specification.

The document management control program 1124 includes therein a specific ACL format access control sub-program 1171, a search control sub-program 1172, an integrated search control sub-program 1173, and a search transfer client control sub-program 1174. The specific ACL format access control sub-program 1171 performs an access control process on a file stored in the document management server 1100. Specifically, the specific ACL format access control sub-program 1171 manages information on an access permission operation or an access rejection operation for the files stored in the document management server 1100 in a format of an access control list (ACL). The specific ACL format access control sub-program 1171 defines ACL in a specific access control information format which is a second access control information format in the document management server 1100 and uses the ACL in the specific format for access control. Defining the specific ACL allows a finer-granularity access control to be performed as compared with the access control based on a general ACL format. Specifically, the contents of finer-granularity operations include, for example, operations with a higher level of abstraction, such as EDIT an APPROVE in addition to basic operations of READ, WRITE, and DELETE.

The search control sub-program 1172 creates a search index of a file group which is stored in the document management server 1100 and searches for a file by utilizing the created index. Based on a search condition designated by a search request to be received from the client apparatus 4100, the integrated search control sub-program 1173 acquires information on the file group matching the search condition in cooperation with other search servers 2100 and then provides an integrated search result to the request source.

The search transfer client control sub-program 1174 operates as a client program, when the integrated search control sub-program 1173 issues a search request to the other search servers 2100. The search result that the search transfer client control sub-program 1174 acquired is provided to the integrated search control sub-program 1173 so as to create an integrated search result.

The file migration control program 1125 includes therein a metadata acquisition control sub-program 1175. The metadata acquisition control sub-program 1175 acquires metadata of a migration target file. The metadata targeted for acquisition also includes ACL information which is used in the specific ACL format access control sub-program 1171 used in the document management server 1100. The acquired metadata is sent to the file server 3100 in a migration destination and the metadata of the target file is stored in the file server 3100.

The search index management table 6100 and the search index registration file management table 6200 are described later.

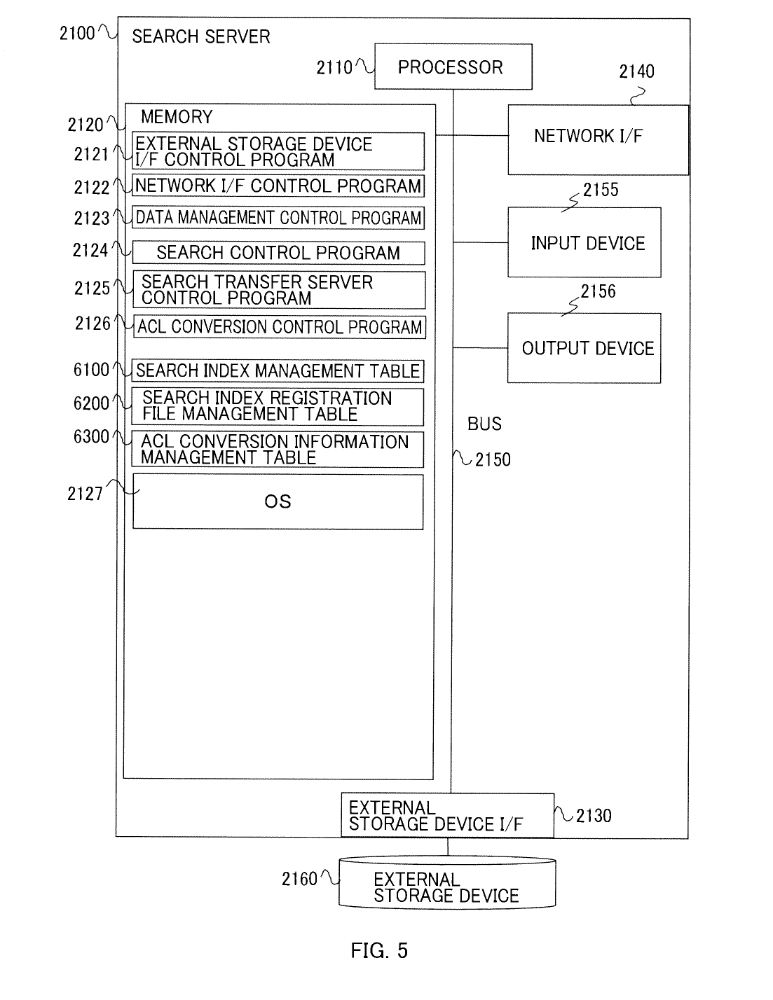

Hereinafter, the configuration and function of the search server 2100 are described. FIG. 5 is an illustration exemplifying the hardware configuration of the search server 2100. The search server 2100 has the hardware configuration similar to that of the document management server 1100 and is configured of a processor 2110 to execute programs, a memory 2120 to temporarily store programs and data, an external storage device I/F 2130 to access an external storage device 2160, a network I/F 2140 to access other devices coupled via a network, and a bus 2150 to connect these components. Similar to the document management server 1100, the search server 2100 also includes an input device 2155 and an output device 2156.

The memory 2120 stores an external storage device I/F control program 2121 which is a program for controlling an external storage device I/F 2130, a network I/F control program 2122 which is a program for controlling a network I/F 2140, a data management control program 2123 for providing a file system or database which is used for managing storage data in the search server 2100, a search control program 2124 for providing a file search service in the search server 2100, a search transfer server control program 2125 for processing a search request from a search transfer client control sub-program 1173 in the document management server 1100, an ACL conversion control program 2126 for converting an ACL format which is used in the specific access control sub-program 1171 in the document management server 1100 for performing security trimming of the search result in the search control program 2124 in the search server 2100 to an ACL format interpretable in the search server 2100, a search index management table 6100 and a search index registration file management table 6200 which are used by the search control program 2124, and an ACL conversion information management table 6300 which is used by the ACL conversion control program 2126. Similar to the document management server 1100, the OS 2127 also runs on the memory 2120.

The search index management table 6100, the search index registration file management table 6200, and the ACL conversion information management table 6300 are described later.

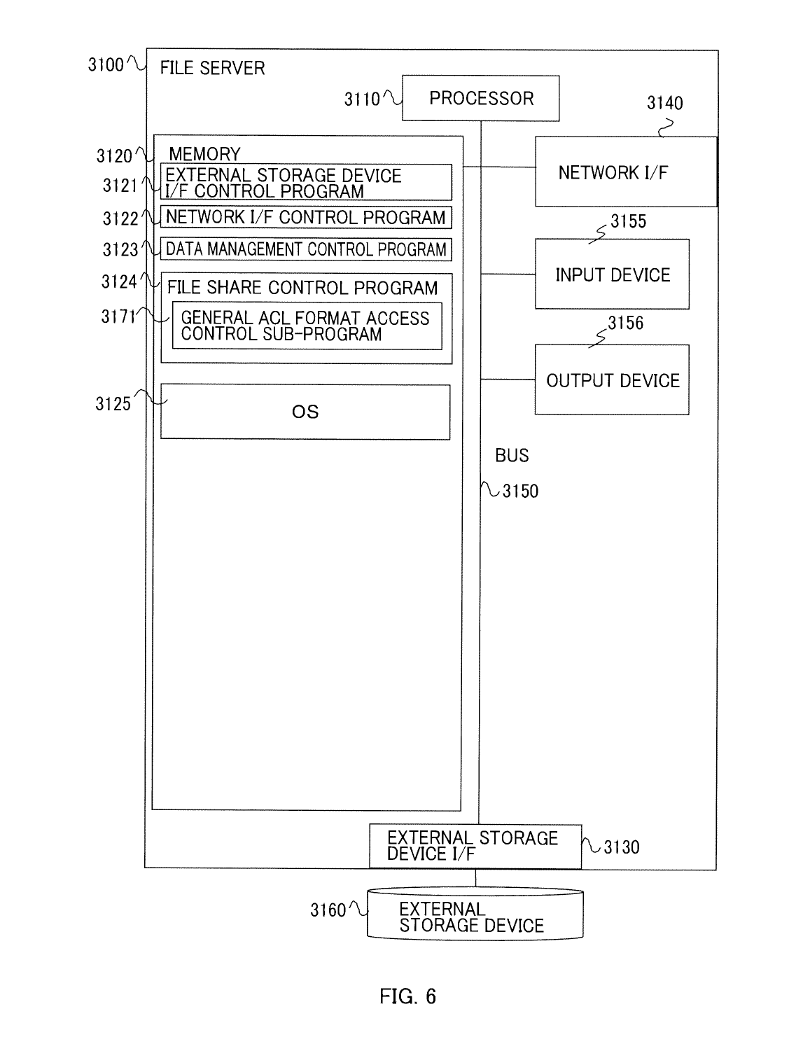

Hereinafter, the configuration and function of the file server 3100 are described. FIG. 6 is an illustration exemplifying the hardware configuration of the file server 3100. The file server 3100 also has the hardware configuration similar to that of the document management server 1100 and is configured of a processor 3110 to execute programs, a memory 3120 to temporarily store programs and data, an external storage device I/F 3130 to access an external storage device 3160, a network I/F 3140 to access other devices coupled via a network, and a bus 3150 to connect these components. Similar to the document management server 1100, the file server 3100 also includes an input device 3155 and an output device 3156.

The memory 3120 stores an external storage device I/F control program 3121 which is a program for controlling the external storage device I/F 3130, a network I/F control program 3122 which is a program for controlling the network I/F 3140, a data management control program 3123 for providing a file system or database which is used for managing stored data in the file server 3100, and a file share control program 3124 for providing a file share service to store and share files in the file server 3100 among multiple users. Similar to the document management server 1100, the OS 3125 also runs on the memory 3120.

The file share control program 3124 includes therein a general ACL format access control sub-program 3171. The general ACL format access control sub-program 3171 performs an access control process on a file stored in the file server 3100, namely the external storage device 3160. More specifically, the general ACL format access control sub-program 3171 manages information on an access permission operation or an access rejection operation for the files stored in the file server 3100 in a format of an access control list (ACL). The general ACL format access control sub-program 3171 uses a general ACL format (a first access control information format) adaptable in the file server 3100 for access control. Utilizing the general ACL format allows other file servers adapted to the general ACL format to be usable. This greatly contributes to enlargement of an applicable range of the document management system 1.

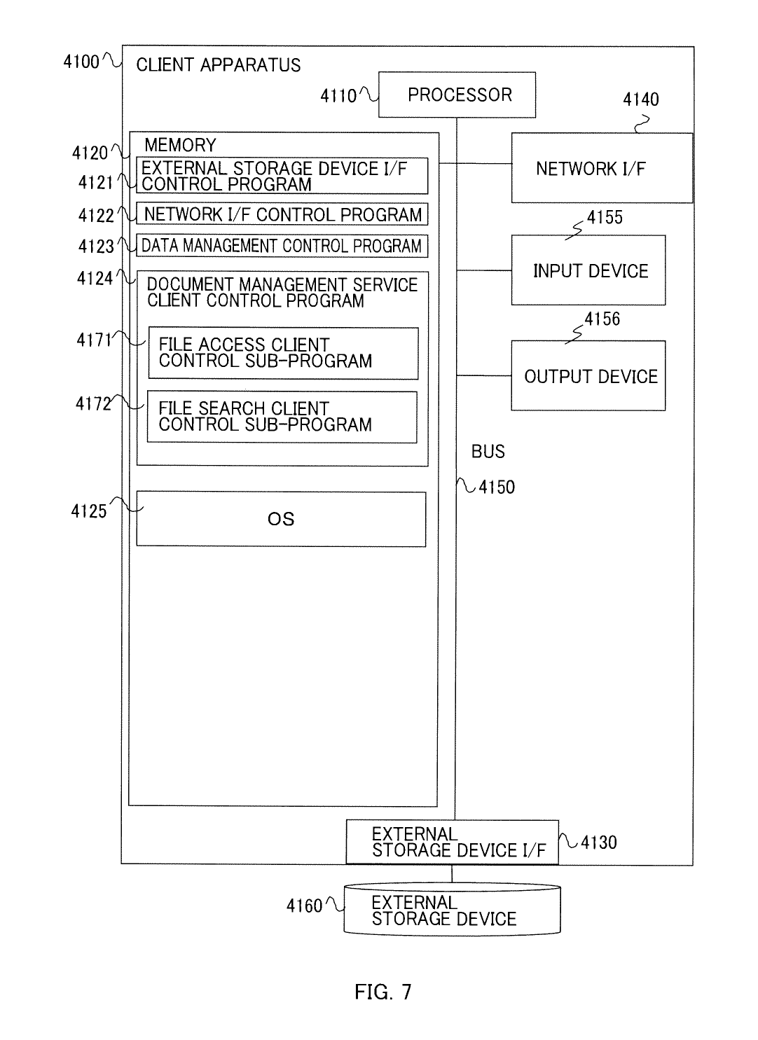

Hereinafter, the configuration and function of the client apparatus 4100 are described. FIG. 7 is an illustration exemplifying the hardware configuration of the client apparatus 4100. Similar to the document management server 1100 or the like, the client apparatus 4100 is also configured of a processor 4110 to execute programs, a memory 4120 to temporarily store programs and data, an external storage device I/F 4130 to access an external storage device 4160, a network I/F 4140 to access other devices coupled via a network, and a bus 4150 to connect these components. Similar to the document management server 1100, the client apparatus 4100 also includes an input device 4155 and an output device 4156.

The memory 4120 stores an external storage device I/F control program 4121 which is a program for controlling the external storage device I/F 4130, a network I/F control program 4122 which is a program for controlling the network I/F 4140, a data management control program 4123 for providing a file system or database which is used for managing stored data in the client apparatus 4100, and a document management service client control program 4124 which is used to access the document management server 1100 from the client apparatus 4100. Similar to the document management server 1100, the OS 4125 also runs on the memory 4120.

The document management service client control program 4124 includes therein a file access client control sub-program 4171 and a file search client control sub-program 4172. The file access client control sub-program 4171 accesses a file stored in the document management server 1100 or stores a file in the document management server 1100. The file search client control sub-program 4172 designates a search condition in response to a search request which is given through the input device 4155 or the like and searches for a file stored in the document management server 1100. In this case, the search target file also includes a file which is stored in the file server 3100 through the document management server 1100.

The document management service client control program 4124 is equivalent to a client program which is provided by a document management server 1100 to be used. The document management service client control program 4124, for example, may use a mode utilizing a web application program for the document management server 1100 or a mode utilizing a general web browser program.

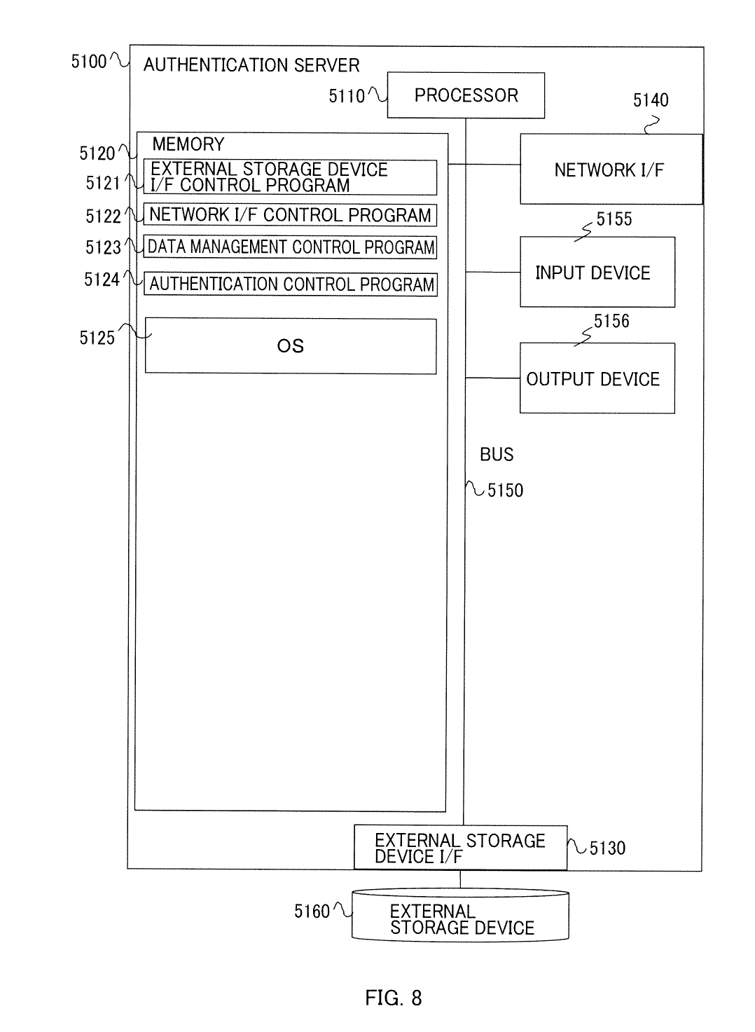

Hereinafter, the configuration and function of the authentication server 5100 are described. FIG. 8 is an illustration exemplifying the hardware configuration of the authentication server 5100. Similar to the document management server 1100 or the like, the authentication server 5100 is also configured of a processor 5110 to execute a program, a memory 5120 to temporarily store programs and data, an external storage device I/F 5130 to access an external storage device 5160, a network I/F 5140 to access other devices coupled via a network, and a bus 5150 to connect these components. Similar to the document management server 1100, the authentication server 5100 also includes an input device 4155 and an output device 4156.

The memory 5120 stores an external storage device I/F control program 5121 which is a program for controlling an external storage device I/F 5130, a network I/F control program 5122 which is a program for controlling the network I/F 5140, a data management control program 5123 for providing a file system or database which is used for managing stored data in the authentication server 5100, and an authentication control program 5124 which achieves an authentication function provided by the authentication server 5100. Similar to the document management server 1100, the OS 5125 also runs on the memory 5120.

The authentication control program 5124 corresponds to a control program for providing information needed for an authentication process and a control program for actually authenticating an authentication target based on information presented by an authentication request source. For example, corresponded are a KDC (Key Distribution Center) server which is used for Kerberos authentication, an LDAP (Lightweight Directory Access Protocol) server which includes authentication target user information managed therein and is used when the authentication process is performed on the user, and the like.

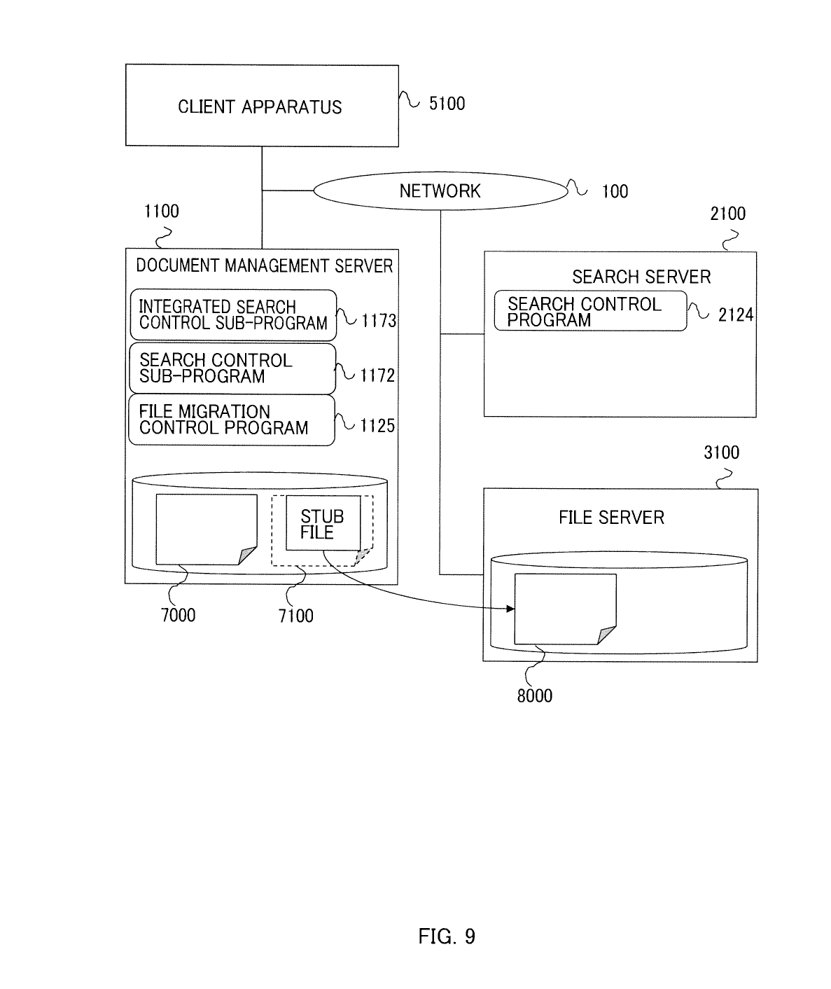

Hereinafter, description is given of a file migration process according to this embodiment. FIG. 9 is an illustration exemplifying system configuration elements relating to a file migration process from the document management server 1100 to the file server 3100 and an integrated search process in which the document management server 1100 and the search server 2100 cooperate. The document management server 1100 uses the file migration control program 1125 so as to be capable of causing a file stored therein to be migrated to the file server 3100. The file migration control program 1125 extracts a migration target file to cause the target file to be migrated to a predetermined file server 3100. When performing the migration process, the file migration control program 1125 replaces a migration source file 7100 on the document management server 1100 with a stub file and stores information for accessing a migration destination file 8000 in the stub file. The stub file means a file in which only substance of the file data of the migration source file 7100 is deleted and the metadata of the file data is kept without being deleted. If a user makes a file access request with respect to the document management server 1100, the user can transparently access the file by using the information stored in the stub file without being conscious about an actual location where the file is stored. If a user makes a file access request with respect to an already-migrated file, the user acquires a file server 3100 in which the target file is actually stored and a file path name in the file server 3100 from the information stored in the target stub file inside the document management server 1100. After that, the document management server 1100 acquires the target file by designating the file path name to the file server 3100.

After the file is migrated, in the search server 2100, the search control program 2124 detects that a new file is stored in the file server 3100 through the migration and creates an index of the file. On the other hand, in the document management server 1100, the file stored in the document management server 1100 is externally migrated through the migration. Thus, it is detected that the file has been deleted from the document management server 1100, and then the index of the file is deleted. As a result, the amount of search index data in the document management server 1100 is reduced, while the amount of search index data in the search server 2100 is increased. Accordingly, if the free storage space of the document management server 1100 gets tight, some of the stored files are migrated, so that not only the storage space which was consumed by the target file but also the storage space of search index data which was consumed for searching for the file can be reduced. In other words, even when the free storage space of the document management server 1100 gets tight, the storage space can be effectively utilized by migrating the files.

However, although the storage space of the document management server 1100 can be effectively utilized through the migration, the migrated files are deleted from the search index in the document management server 1100. Consequently, there is a drawback in that the migrated files cannot be searched in the document management server 1100 itself. Accordingly, the document management server 1100 is designed so that the integrated search control sub-program 1173 can perform integrated search in cooperation with the search server 2100 indexing a migration destination file. With the integrated search, the integrated search control sub-program 1173 can acquire a search result acquired by the search control sub-program 1172 inside the document management server 1100 together with a search result acquired by the search control program 2124 inside the search server 2100. The integrated search control sub-program 1173 of the document management server 1100 integrates these search results and provides the integrated result to the search request source.

When performing the integrated search, each search server 2100 makes a request such that information of the search user issuing the search request is sent together with the transmitted search request. The search server 2100 performs user authentication based on the transmitted search user information. After the user authentication, the security trimming of the search result is performed based on privileges given to the target user. As described above, the security trimming is performed by each search server 2100 participating in the integrated search, so that the integrated search result to be finally provided to a user can be also subjected to the security trimming. It is also natural that the document management server 1100 which creates an integrated search result collectively performs security trimming.

In order to perform this security trimming, the search server 2100 needs to acquire and interpret ACL information which is set for a target file in the document management server 1100. However, the ACL information which is used in the document management server 1100 may have a specific ACL format. In this case, there is a problem that the ACL information cannot be interpreted by the search server 2100 when the ACL information is acquired in the specific format. For this reason, the specific ACL format needs to be converted to a general ACL format. If all pieces of information are aimed to be converted when the conversion to a general ACL format is performed, one part of the ACL information may become missing. To deal with the situation, only information needed for the security trimming in the search server 2100 is extracted from the ACL information and the extracted ACL information is converted to information in a general ACL format.

For indexing a file stored in the file server 3100, it is only needed to acquire (READ) the file from the search server 2100. Since the search server 2100 does not need to update or delete the file stored in the file server 3100, the ACL information on these operations is unnecessary.

The search server 2100 needs to determine which user or group can refer (READ) to the indexing target file. Accordingly, it is designed so that the search server 2100 performs minimum required ACL conversion for acquiring these two pieces of information.

In this connection, it is designed so that the operation of updating or deleing the file migrated to the file server 3100 is performed by the document management server 1100 with respect to the file server 3100. In this case, the access control relating to the target file is performed based on the specific ACL format in the document management server 1100. Thus, the access control may be performed according to the specific ACL format. In addition, it is only needed that the access control of updating or deleting a file can be performed in the file server 3100 according to the request made by the document management server 1100 without converting the format.

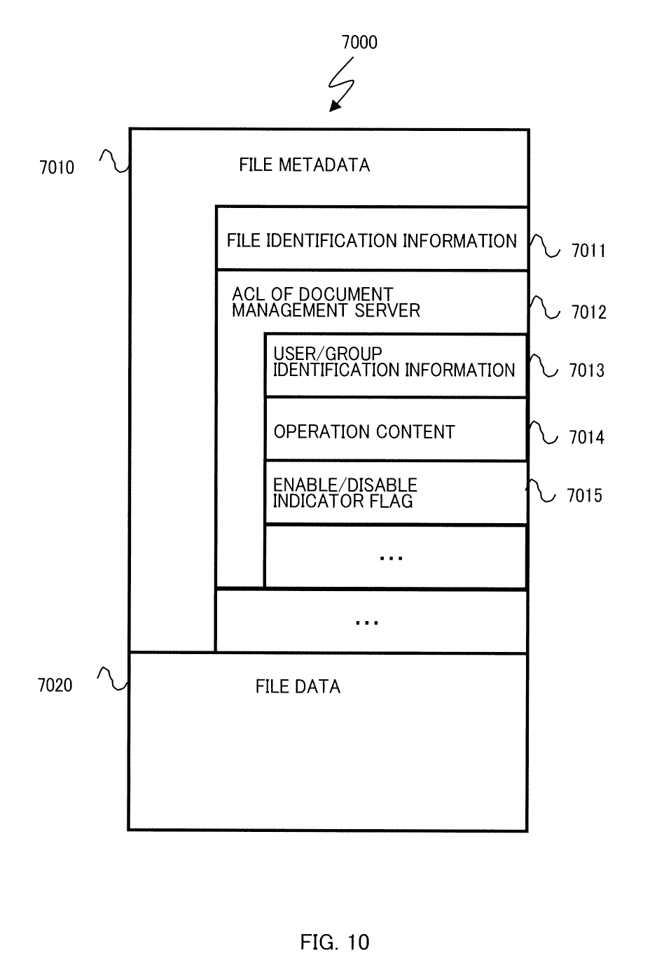

Hereinafter, description is given of a file to be stored in the document management server 1100. FIG. 10 is an illustration exemplifying the data structure of a file stored in document management server 7000. The file stored in document management server 7000 includes file metadata 7010 and file data 7020. The file metadata 7010 includes file identification information 7011 and ACL 7012 of the document management server 1100. Although it is not shown in FIG. 10, the file metadata 7010 also includes metadata which is generally added to a file, such as a file creation time and a latest update time. The ACL 7012 of the document management server 1100 is formed of multiple sets, each including, as one set, user/group identification information 7013, an operation content 7014, and an enable/disable indicator flag 7015. With this set, a user or group which is designated by the user/group identification information 7013 can enable or disable an operation designated by the operation content 7014 through the enable/disable indicator flag 7015. Registering multiple sets allows the access control using multiple combined conditions to be performed. Moreover, the operation content 7014 can individually define the operation content based on the specific ACL format defined by the document management server 1100. The file data 7020 includes actual data of the target file stored therein.

If the file stored in document management server 7000 is a stub file 7100 showing that migration is performed, storage information of the migration destination have to be stored somewhere. The storage information may be stored here as one element of the file metadata 7010 or as the file data 7020.

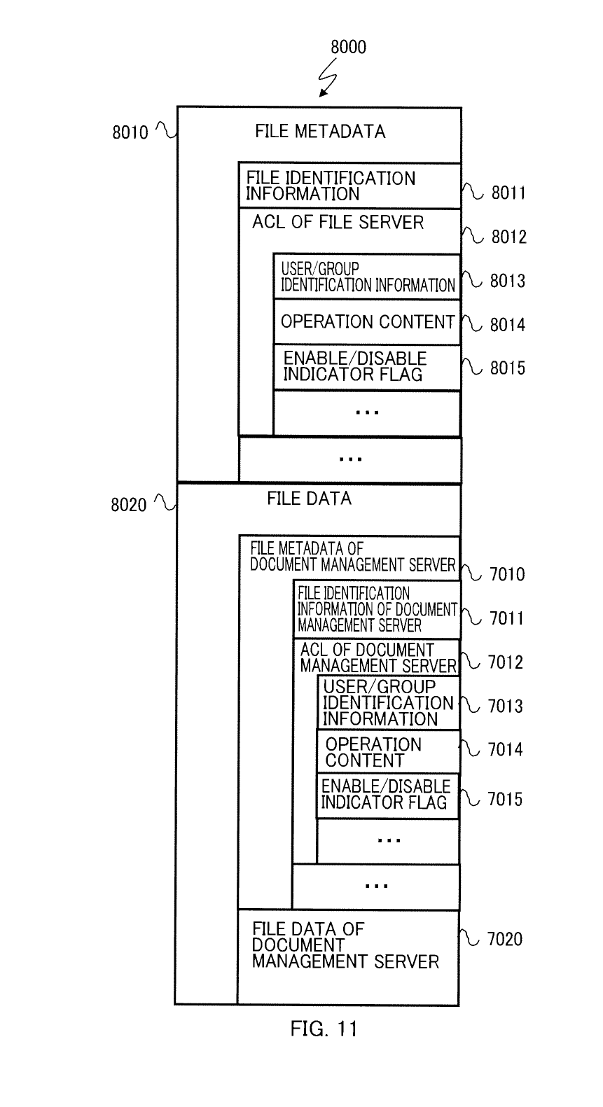

Hereinafter, description is given of a file to be stored in the file server 3100. FIG. 11 is an illustration exemplifying the data structure of a file stored in file server 8000. The file stored in file server 8000 includes file metadata 8010 and file data 8020. The file metadata 8010 includes file identification information 8011 and ACL 8012 of the file server 3100. Although it is not shown in FIG. 11, the file metadata 8010 also includes general metadata, such as a file creation time and a latest update time. The ACL 8012 of the file server 3100 is formed of multiple sets, each including, as one set, user/group identification information 8013, an operation content 8014, and an enable/disable indicator flag 8015. With this set, a user or group which is designated by the user/group identification information 8013 can enable or disable an operation designated by the operation content 8014 through the enable/disable indicator flag 8015. Registering multiple sets allows access control using multiple combined conditions to be performed. The operation content 8014 is designated as an operation content based on a general ACL format. For example, the general ACL format includes a POSIX ACL format or an NTFS ACL format. Although it is not an ACL format, access permission information present as file access control information in a file system which is used in Linux (registered trademark) OS or the like may be designated. This access permission information is to designate whether or not a READ operation, WRITE operation, or EXECUTE operation for a target file is enabled or disabled with respect to each of an owner user, a affiliation group, and a user outside the affiliation group of the target file.

The file data 8020 includes actual data of the target file stored therein. If the target file is migrated from the document management server 1100, the configuration of the data becomes like that in FIG. 11. As the metadata of the file stored in document management server 7000, the file data 8020 includes therein the file metadata 7010 of the document management server 1100 and the file date 7020 of the document management server 1100. The internal configuration of the file metadata 7010 of the document management server 1100 is similar to that described above, and thus the description thereof is omitted here.

If the target file is migrated from the document management server 1100, a configuration other than that shown in FIG. 11 is also possible. For example, the configuration may include the file metadata 7010 of the document management server 1100 as one element of the file metadata 8010.

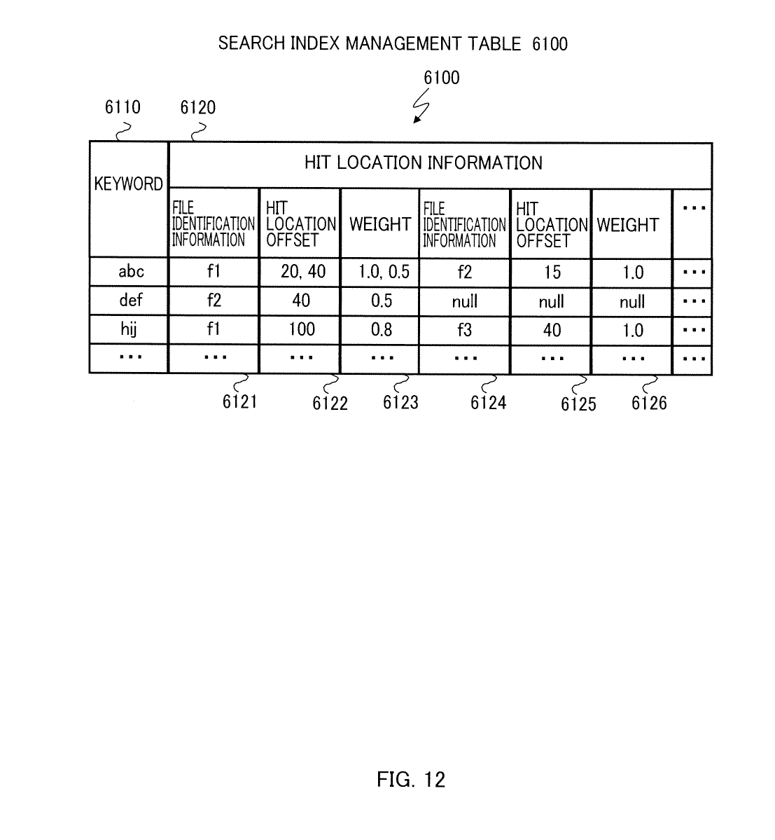

Hereinafter, description is given of the search index management table 6100. FIG. 12 is an illustration exemplifying the configuration of the search index management table 6100 which is managed on the document management server 1100 or the search server 2100. The search index management table 6100 manages information of search index created by the document management server 1100 or the search server 2100. Specifically, the search index management table 6100 includes as configuration information, a keyword 6110 and hit location information 6120.

The keyword 6110 stores a character string obtained by analyzing the target file through the indexing process. The hit location information 6120 registers file information in which the character string of the keyword 6110 is present. This hit location information 6120 is formed of components such as file identification information 6121, 6124, hit location offset 6122, 6125, and weight 6123, 6126. The file identification information 6121, 6124 registers information for identifying a file in which the character string of the keyword appears. Specifically, the information file identification information 6121, 6124 may register information in a column of the file identification information 6210 in the search index registration file management table 6200 to be described later or a file path name or file identifier which is used at the time of making an actual access to the target file. The hit location offsets 6122, 6125 register offset information in which the character string of the keyword appears in the file. In this column, if the keyword appears in multiple locations in one file, multiple pieces of offset information are registered. The weight 6123, 6126 registers a value of significance when the character string of the keyword appears in the offset of the file. This value of significance is set by the document management server 1100 or the search server 2100 as needed. This value means that the significance is higher the larger the value. In addition, the value can be used for refining or aligning search results. It is designed here that multiple pieces of the hit location information 6120 can be registered for one keyword 6110. This allows the case where there are multiple files corresponding to the keyword character string to be handled. In the column of the hit location information 6120, a null value meaning that a value of an entry is invalid may be registered. This can be used for an entry whose item becomes empty in the column of the hit location information 6120 in a case where the number of registrations is smaller than those of other entries.

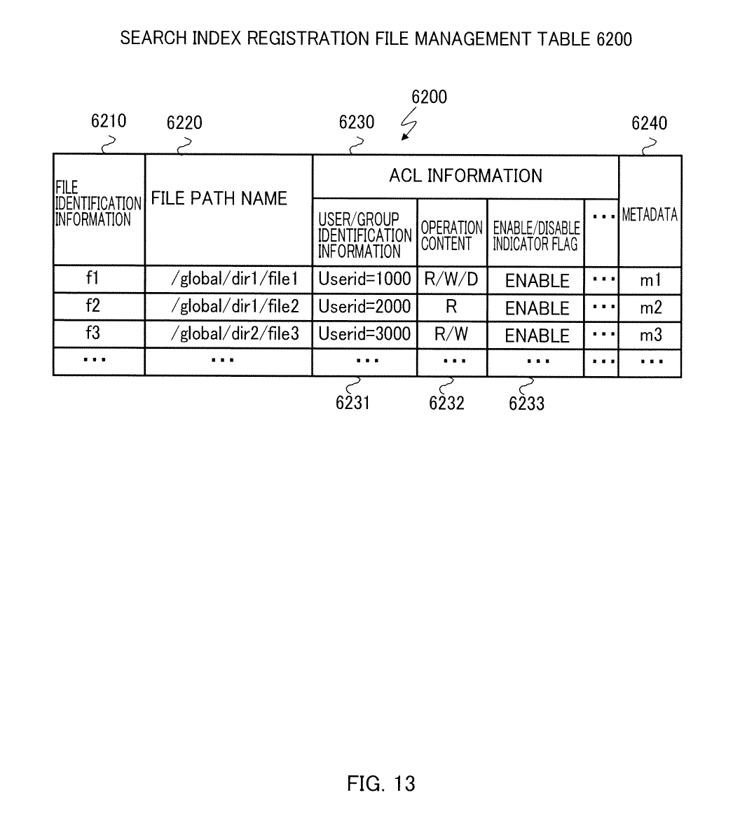

Hereinafter, description is given of the search index registration file management table 6200. FIG. 13 is an illustration exemplifying the configuration of the search index registration file management table 6200 which is managed on the document management server 1100 or the search server 2100. The search index registration file management table 6200 manages information on a file acquired from the document management server 1100 or the file server 3100, the file targeted by the document management server 1100 or the search server 2100 for creating a search index. Specifically, the search index registration file management table 6200 includes components such as file identification information 6210, a file path name 6220, ACL information 6230, and metadata 6240.

The file identification information 6210 is an identifier to uniquely identify the file acquired by the document management server 1100 or the search server 2100 for creating a search index. The identifier may be a serial number which is given by the document management server 1100 or the search server 2100, or it may be a serial number which is given by the file-acquired document management server 1100 or the file server 3100. In addition to a serial number, a character string capable of being used for identification may be used. The file path name 6220 is equivalent to a file path name in which the target file is stored. Thus, the document management server 1100 or the search server 2100 can acquire the file by designating the file path name 6220 and making a file acquisition request to the file server 3100. The ACL information 6230 is equivalent to the ACL information acquired as one element of the metadata at the time of indexing the target file. The ACL information 6230 is formed of multiple sets, each including, as one set, user/group identification information 6231, an operation content 6232, and an enable/disable indicator flag 6233. With this set, the enable/disable indicator flag 6233 causes a user or group designated by the user/group identification information 6231 to enable or disable an operation designated by the operation content 6232 for the file identified by the file identification information 6210. Registering these multiple sets allows access control using multiple combined conditions to be performed. Moreover, the operation content 6232 may individually define the operation content based on the specific ACL format defined by the document management server 1100 or may designate an operation content based on a general ACL format. For example, in FIG. 13, when the operation content 6232 is “R”, it means “READ access”, “W” means “WRITE access”, and “D” means “DELETE”. Of course it is not necessary to follow this format and other formats may be used. Finally, the metadata 6240 stores metadata acquired at the time of indexing the target file.

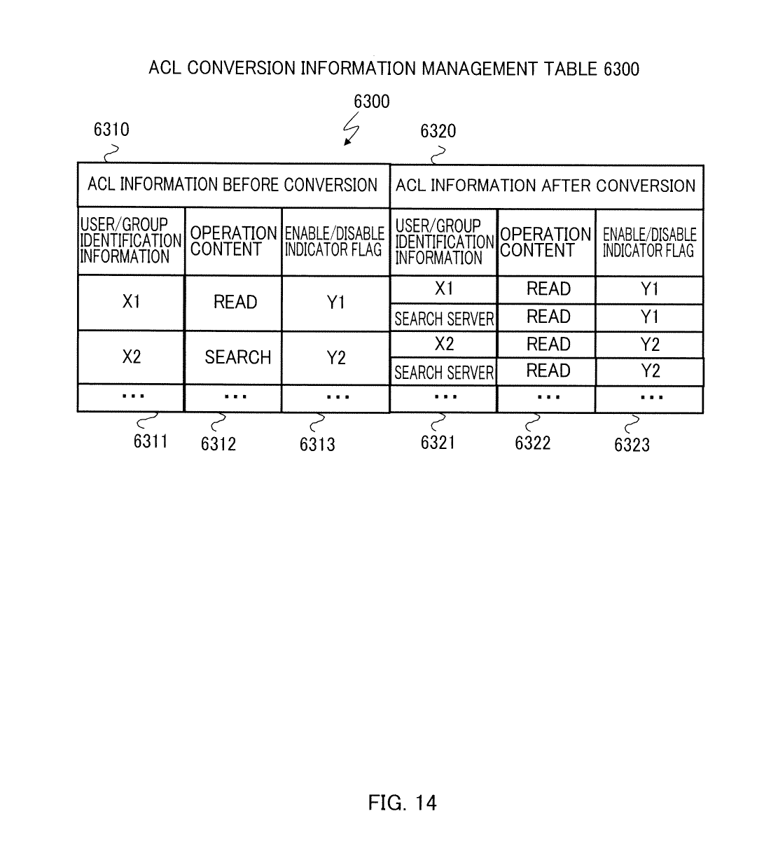

Hereinafter, description is given of the ACL conversion information management table 6300. FIG. 14 is an illustration exemplifying the configuration of the ACL conversion information management table 6300 which is managed on the search server 2100. The ACL conversion information management table 6300 manages corresponding information for converting ACL information set by the document management server 1100 to ACL information in a format interpretable even by the search server 2100. Specifically, the ACL conversion information management table 6300 is formed of components such as ACL information before conversion 6310 and ACL information after conversion 6320.

The ACL information before conversion 6310 and the ACL information after conversion 6320 include components such as user/group identification information 6311, 6321, an operation content 6312, 6322, and an enable/disable indicator flag 6313, 6323, respectively. The components of the ACL information before conversion 6310 are the same as those of the ACL 7012 which is used in the document management server 1100 described in FIG. 10. Also, the components of the ACL information after conversion 6320 are the same as those of the ACL 8012 of the file server 3100 described in FIG. 11. The ACL information before conversion 6310 can register the operation content 6312 based on the specific ACL format which is used in the document management server 1100. On the other hand, the ACL information after conversion 6320 can register the operation content 6322 based on a general ACL format which is used in the file server 3100 or the like.

In the process shown in FIG. 14, when there is ACL information whose content is the same as that registered as the ACL information before conversion 6310, it means that the content of the ACL information is converted to the content registered as the ACL information after conversion 6320. With this process, when a migration file is read from the file server 3100 and ACL information in a specific format set in the document management server 1100 is acquired, the specific ACL format is converted to an ACL format usable in the search server 2100 by utilizing this table. For example, FIG. 14 shows the case where, as the ACL information before conversion 6310, “X1”, “READ”, and “Y1” are respectively registered in the columns of the user/group identification information 6311, the operation content 6312, and the enable/disable indicator flag 6313. Based on this, the ACL information in a specific format registered in the target file is read and an entry whose operation content is set “READ” is searched out. When the entry is found, the ACL information is converted to the ACL information after conversion 6320 corresponding to the ACL information before conversion 6310. In other words, the information in the column of the operation content, which is “READ”, and the corresponding information in the columns of the user/group identification information 6311 and the enable/disable indicator flag 6313, which are respectively “X1” and “Y1”, are set in the corresponding columns of the ACL information after conversion 6320. In addition, as the ACL information after conversion 6320, identification information of the using search server 2100 and a value of the enable/disable indicator flag 6313 before conversion are respectively set in the columns of the user/group identification information 6321 and the enable/disable indicator flag 6323. Accordingly, a user or group which is set by the ACL information before conversion 6310 so as to enable or disable the READ operation can be set, as the ACL information after conversion 6320, so as to enable or disable the READ operation. Furthermore, as long as there is present a user or a group which enables the READ operation for the file, the READ operation from the search server 2100 which creates a search index can be set enable or disable. If the content whose level of abstraction is high is recorded, such as “SEARCH” in FIG. 14, as the operation content 6312 of the ACL information before conversion 6310, a general operation content such as “READ” usable even in a general ACL format is recorded in the ACL information after conversion 6320.

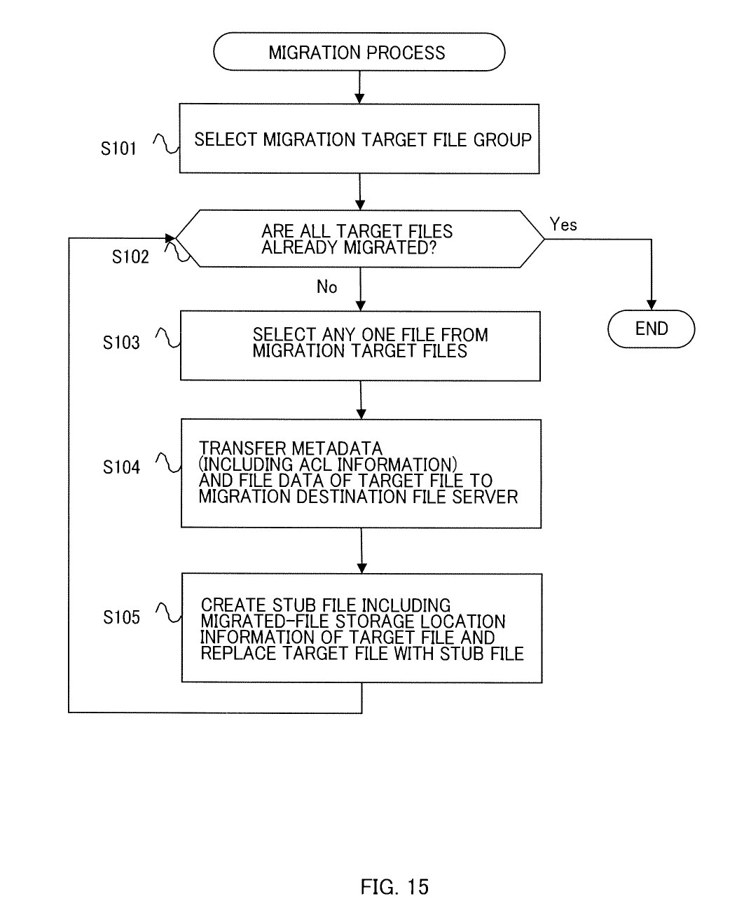

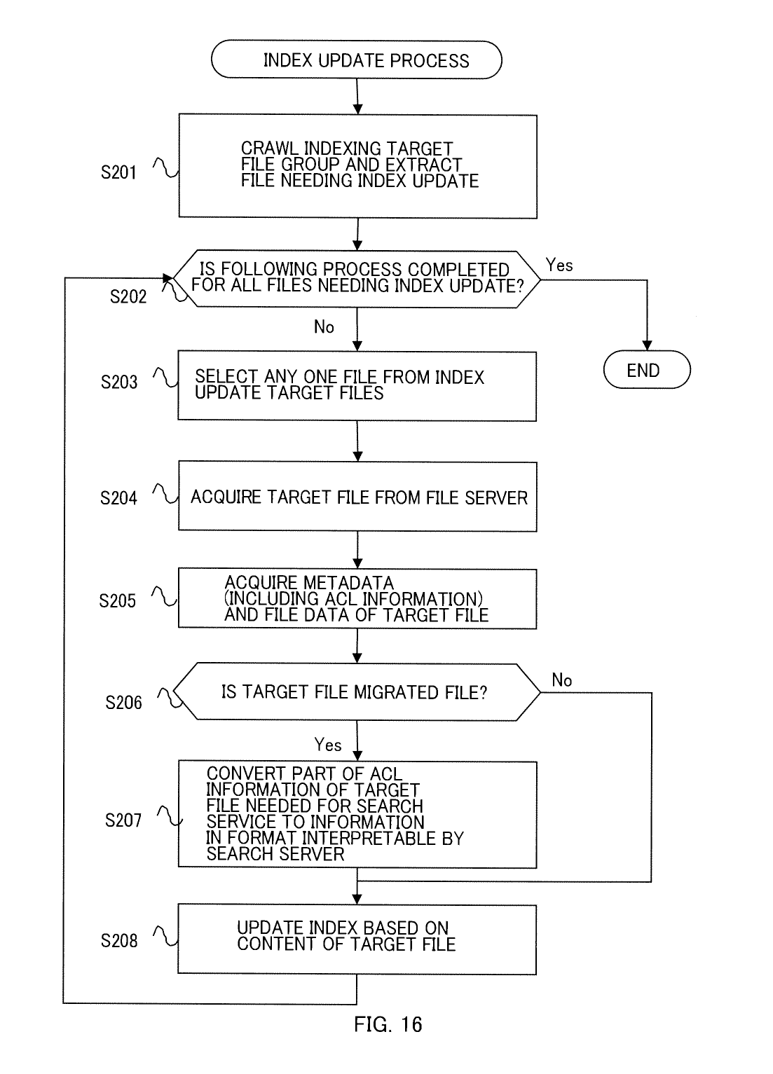

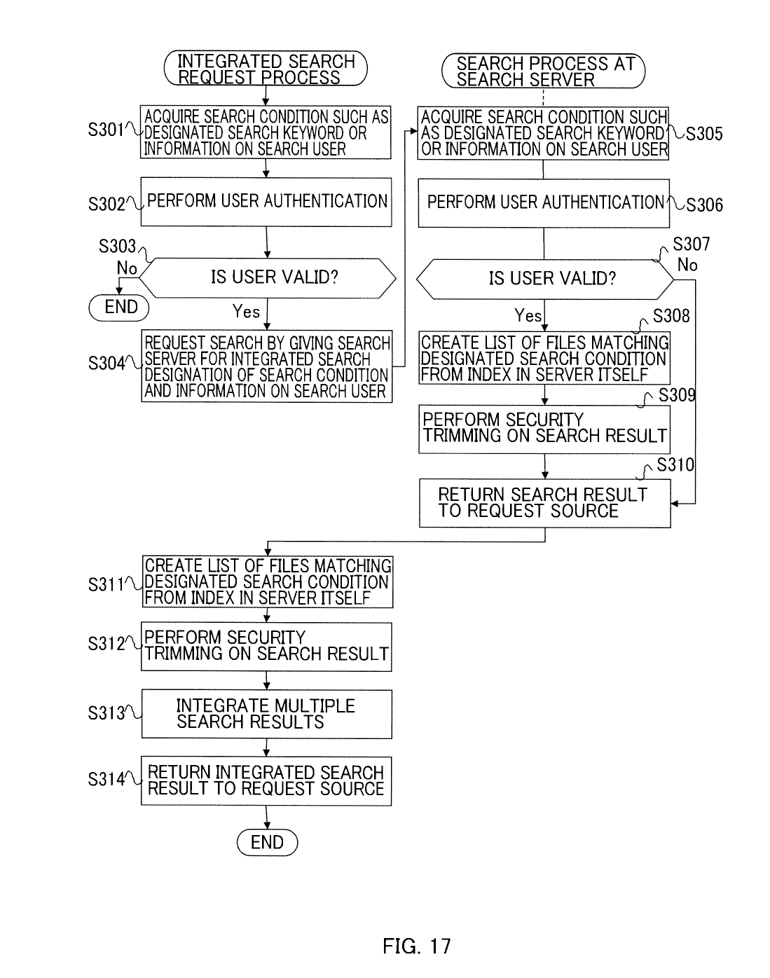

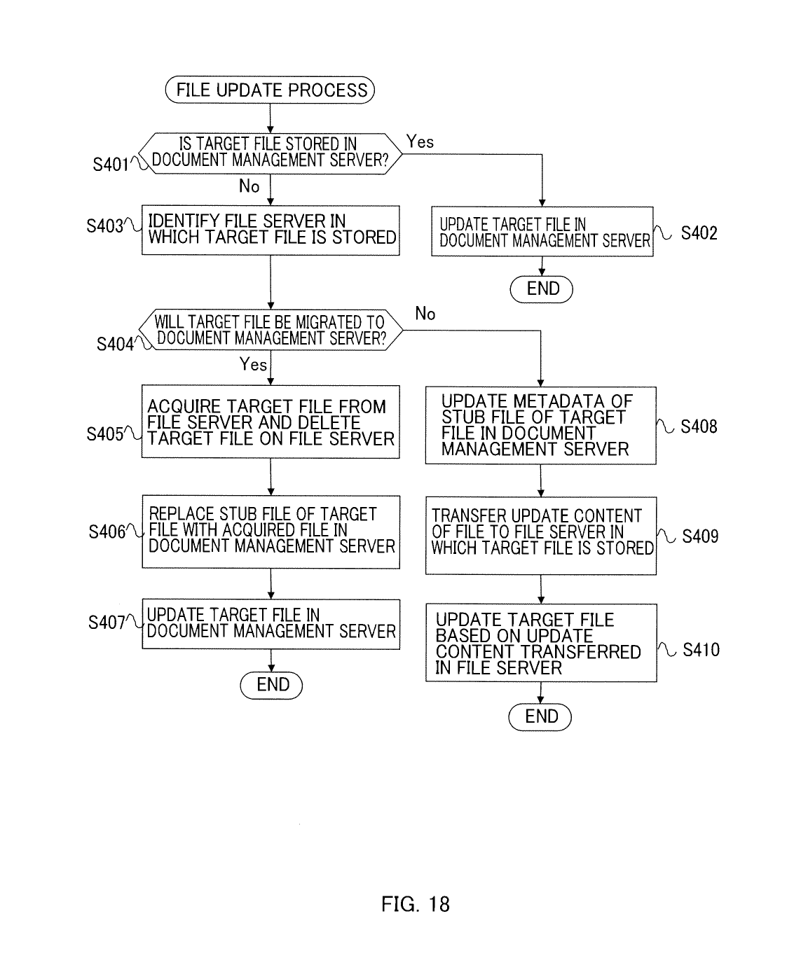

In the foregoing description, the system configuration, file data structure, management information configuration, which are provided in the embodiment of this invention have been discussed. In the following description, a processing method which is implemented by the embodiment of the invention is described. The description is given here to a file migration process (FIG. 15), an index update process (FIG. 16), an integrated search request process (FIG. 17), and a file update process (FIG. 18) referring to the drawings.

FIG. 15 shows a flow of a file migration process from the document management server 1100 to the file server 3100. The file migration process is executed by the file migration control program 1125. Firstly, the document management server 1100 selects a file group targeted for migration to the file server 3100 from the files stored therein (S101). The migration target file selection method may use any method. For example, it may be designed such that a file which has past a specific time since the target file has been created is selected or that a file which has past a specific time since the target file has been accessed the last time is selected. After the migration target file is selected, the document management server 1100 checks whether or not all target files are already migrated (S102). If it is determined that all files are migrated (if Yes at step S102), the current process is terminated. If it is determined that not all files are migrated (if No at step S102), the process proceeds to processes described below.

Thereafter, the document management server 1100 selects any one file from the migration target files (S103). Then, the document management server 1100 transfers metadata (including ACL information) and file data of the target file to the file server 3100 in a migration destination (S104). The file server 3100 having received the transfer request stores the file therein and transmits storage location information of the target file to the request source document management server 1100. After that, the document management server 1100 creates a stub file including migrated-file storage location information of the target file and replaces the target file with the stub file (S105). With the process described above, the file selected as a migration target on the document management server 1100 can be migrated to the file server 3100.

After the target file is migrated, the migrated file is already absent from the document management server 1100 when the search control sub-program 1172 in the document management server 1100 performs index update of the file stored in the document management server 1100. Thus, the migrated file is deleted from the index.

Hereinafter, the index update process is described. FIG. 16 shows a flow of a search index update process which is implemented by the search control program 2124 in the search server 2100. Firstly, the search server 2100 performs the crawling of an indexing target file group and extracts a file group needing index update (S201). It is assumed here that the search server 2100 performs the crawling in the file server 3100 in which a search target file is stored. Whether or not the index update is needed can be determined whether or not the file is updated since the previous indexing update. After that, the search server 2100 checks whether or not the process to be described below is completed for all files needing the index update (S202). If it is determined that the process is completed for all files (Yes at S202), the current process is terminated. If it is determined that the process is not completed for all files (No at 5202), the process to be described below is performed.

Thereafter, the search server 2100 selects any one file from the index update target files (S203). The following process is performed on the file selected as above. Then, the search server 2100 acquires a target file from the file server 3100 (S204). Then, the search server 2100 acquires metadata (including ACL information) and file data of the target file (S205). The information acquired as above also includes ACL information in a general format set in the file server 3100 and ACL information in a specific format set in the document management server 1100. Next, the search server 2100 checks whether or not the target file is a migrated file (S206). If it is determined that the target file is a migrated file (Yes at S206), the process proceeds to step S207, while if it is determined that the target file is not a migrated file (No at S206), the process moves to step S208. Whether or not the target file is a migrated file can be confirmed by using a method of checking a form of data body stored in the file or a method of checking whether or not attribute information showing that the file is a migrated file is included in the file metadata. In the case of the former method, it is checked if the data structure inside the file data is the same as that shown in FIG. 11. If the data structure is same, it may be determined that the file is a migrated file. Also in the case of the latter method, an attribute showing that the file is a migrated file may be set as an attribute of the file metadata when the file is created and stored in the file server 3100. The search server 2100 can determine whether or not the file is a migrated file based on the attribute.

If it is determined at step S206 that the target file is a migrated file, the search server 2100 converts information needed for the search service, which is a part of ACL information of the target file set in the document management server 1100, to information in a format interpretable by the search server 2100 (S207). This conversion is performed by using the information registered in the ACL conversion information management table 6300 described in FIG. 14. Finally, the search server 2100 updates the index based on the content of the target file acquired by the crawling (S208). It is also possible that information for performing differential update on the index is extracted from the target file to update the index, or that information for creating an index is extracted from the target file to update the index by overwriting. If the above step S207 is performed, the ACL information to be reflected in the index at the time of the index update is ACL information after conversion which is created at step S207. When step S208 is completed, the process returns to step S202 to continue the subsequent processes.

Hereinafter, the integrated search process is described. FIG. 17 shows a flow of an integrated search process which is implemented by the document management server 1100 and the search server 2100. Firstly, the document management server 1100 acquires a search condition such as a search keyword designated by the search user requesting an integrated search or information on the search user (S301). Then, the document management server 1100 performs user authentication for the search user (S302). The user authentication performed here may be such that the information on the search user is interpreted and authenticated inside the document management server 1100 or that a user authentication process is requested to the authentication server 5100 to acquire a result thereof. If it is determined that the search user is a valid user as a result of the user authentication process (Yes at S303), the process after S304 is performed. On the other hand, if it is determined that the search user is not a valid user (No at S303), it is regarded that the authentication failed and the process is terminated.

After the user authentication succeeds, the document management server 1100 requests the search server 2100 performing the integrated search to perform search by designating the search condition and the information on the search user (S304). Here, the document management server 1100 utilizes the search transfer client control sub-program 1174 to give a search request to the search server 2100. Also, the search server 2100 receives the search request utilizing the search transfer server control program 2125 to perform the process to be described below.

The search server 2100 having received the search request acquires the search condition such as a designated search keyword or information on the search user (S305). The search user information is information on the search user who originally requests the integrated search.

Then, the search server 2100 performs user authentication for the search user (S306) and checks whether or not the user is a valid user (S307). The user authentication performed here may be such that the information on the search user is interpreted and authenticated inside the search server 2100 or that a user authentication process is requested to the authentication server 5100 and acquires a result thereof. If it is determined that the search user is a valid user as a result of the user authentication process (Yes at S307), the process after 5308 is performed. On the other hand, if it is determined that the search user is not a valid user (No at S307), it is regarded that the authentication failed and the process after S310 is performed.

After the user authentication succeeds, the search server 2100 creates, as a search result, a list of files matching the designated search condition from the index in the server itself (S308). After the search result is created, the search server 2100 performs the security trimming on the search result (S309). The information registered in the search index registration file management table 6200 described in FIG. 13 is utilized to check whether or not the search user enables READ operation for the file included in the search result. If there is no right for READ operation, the file information is deleted from the search result. The security trimming performed at step S309 may be performed in the process of creating the search result at step S308.

After that, the search server 2100 returns the search result to the request source document management server 1100 (S310). If it is determined at step S307 that the search user is not a valid user, that is, if the authentication has failed, the document management server 1100 receives information showing that the user authentication failed and also that the number of search results acquired by the search server 2100 is zero.

The document management server 1100 having received the response from the search server 2100 creates, as a search result, a list of files matching designated search condition from the index in the server itself. After the search result is created, the document management server 1100 performs the security trimming on the search result (S312). Similar to the foregoing, the information registered in the search index registration file management table 6200 described in FIG. 13 is utilized to check whether or not the search user enables READ operation for the file included in the search result. If there is no right for READ operation, the file information is deleted from the search result. The security trimming performed at step S312 may be performed in the process of creating the search result at step S311.

Hereinafter, the document management server 1100 integrates the search results acquired at steps S309 and S312 as an integrated search result (S313). The document management server 1100 can adapt various methods to integrate multiple search results. For example, it is possible that a search result is weighted for each search server in advance, and an integrated search result is ranked based on the information. It is also possible that ranking can be commonly made in the document management server 1100 and the search server 2100, and then an integrated search result is ranked based on the ranking information. Finally, the search server 2100 returns the integrated search result to the request source search user (S314).

Hereinafter, the file update process is described. FIG. 18 shows a flow of a file update process which is implemented in the document management server 1100. Firstly, the document management server 1100 checks whether or not an update target file is stored in the document management server 1100 (S401). If it is determined that the update target file is stored in the document management server 1100 (Yes at S401), the target file is updated in the document management server 1100 (S402) and the process is terminated. If it is determined that the update target file is not stored in the document management server 1100 (No at S402), the file server 3100 in which a file targeted for update is stored is identified (S403). To identify the file server 3100, migrate-file storage location information which is stored in a stub file in the document management server 1100 is checked. Thereafter, the document management server 1100 determines whether or not the update target file will be migrated from the file server 3100 to the document management server 1100 along with the file update process (S404). The determination whether or not migration is to be made may be fixedly set as system setting information or may be made for each file.

If it is determined at step S404 that the update target file will be migrated to the document management server 1100 (Yes at S404), the document management server 1100 acquires the update target file from the file server 3100 and requests that the update target file on the file server 3100 to be deleted (S405). Then, the document management server 1100 replaces the stub file corresponding to the update target file with the file acquired by the previous process (S406). Finally, the document management server 1100 updates the update target file (S407).

On the other hand, if it is determined at S404 that the update target file will not be migrated to the document management server 1100 (No at S404), the document management server 1100 updates metadata of the stub file of the update target file (S408). The metadata relating to the latest update time of the update target file is updated or the metadata is updated when the update process is for updating the metadata. After that, the document management server 1100 transfers the file update content to the file server 3100 in which the update target file is stored (S409). The file migration control program 1125 transfers the file update content here. Finally, the file server 3100 to which the file update content is transferred updates the update target file based on the transferred update content (S410).

The file update process is implemented by the process as described above. This file update process is applicable to both cases where the file migrated to the file server 3100 is returned to the document management server 1100 at the time of the file update process and where the stub file is maintained without returning the migrated file to the document management server 1100.

In the foregoing description, the first embodiment of the invention has been discussed. However, the invention is not limited to the first embodiment. It is needless to say that the invention includes various configurations within a range which does not depart from the scope of the invention.

### Second Embodiment

Next, another example of the embodiment is described. The first embodiment uses a mode which assumes that the access control of a file stored in the document management server 1100 and the security trimming of a search result performed by the search server 2100 are performed based on the ACL information which is set for each file. However, if a large quantity of files is intended to be managed in the document management server 1100, it requires a large number of processes to set or update ACL information for each file. Thus, it is often difficult to be implemented. In general, an ACL inheritance function is often used to efficiently set or update ACL information with respect to a large quantity of files. The ACL inheritance function is a function that can inherit and reflect ACL information set for any directory to and in a sub-directory thereof or a storage file under the environment that a directory capable of storing multiple files is managed hierarchically in a tree structure. Use of this ACL inheritance function allows ACL information of the large quantity of files to be efficiently and collectively updated.

If ACL information is collectively updated in the document management server 1100, the search server 2100 also needs to perform the index update on an update target file. Here, the search server 2100 may specify the update target file by the conventional crawling process. However, there is a problem in that the index update process to be performed along with the update becomes a high load when a large quantity of files is collectively updated. For this reason, a mechanism in which ACL change content is efficiently reflected in the search index when the batch update process is performed is essential. Thus, hereafter, description is given of a control method as the second embodiment in which ACL batch update information needed for implementing the security trimming of the search result is efficiently reflected in the search server 2100, even when ACL information of the files stored in the document management server 1100 is collectively updated by using the ACL inheritance function.

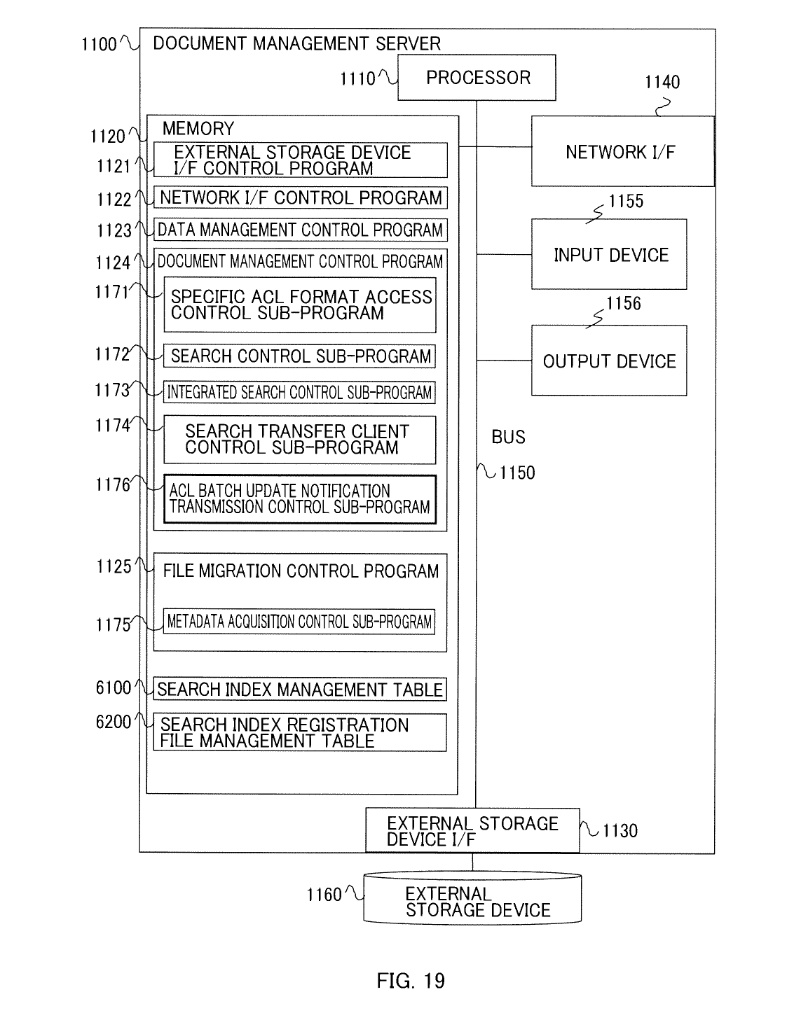

As described above, to efficiently reflect the ACL batch update information, the document management server 1100 further newly requires a function to notify the search server 2100 of the ACL batch update content, a reflection process in the search server 2100 when the ACL batch update content notification is received and reflected in the search index, and a management table for managing information on the ACL batch update. These added contents and changed contents are described by referring to FIGS. 19, 20, 21, 22, 23, and 24.

FIG. 19 shows contents of changes in the configuration in the illustration exemplifying the hardware configuration of the document management server 1100 described in FIG. 4. In FIG. 19, an ACL batch update notification transmission control sub-program 1176 is added anew to the document management control program 1124 in addition to the components shown in FIG. 4. Other components are not changed. Description is given of the components newly added here.

If the ACL batch update notification transmission control sub-program 1176 performs the ACL information batch update utilizing the ACL inheritance function on the storage file in the document management server 1100, the processing to notify the search server 2100 of the batch update content is performed. This specific processing flow is described later.

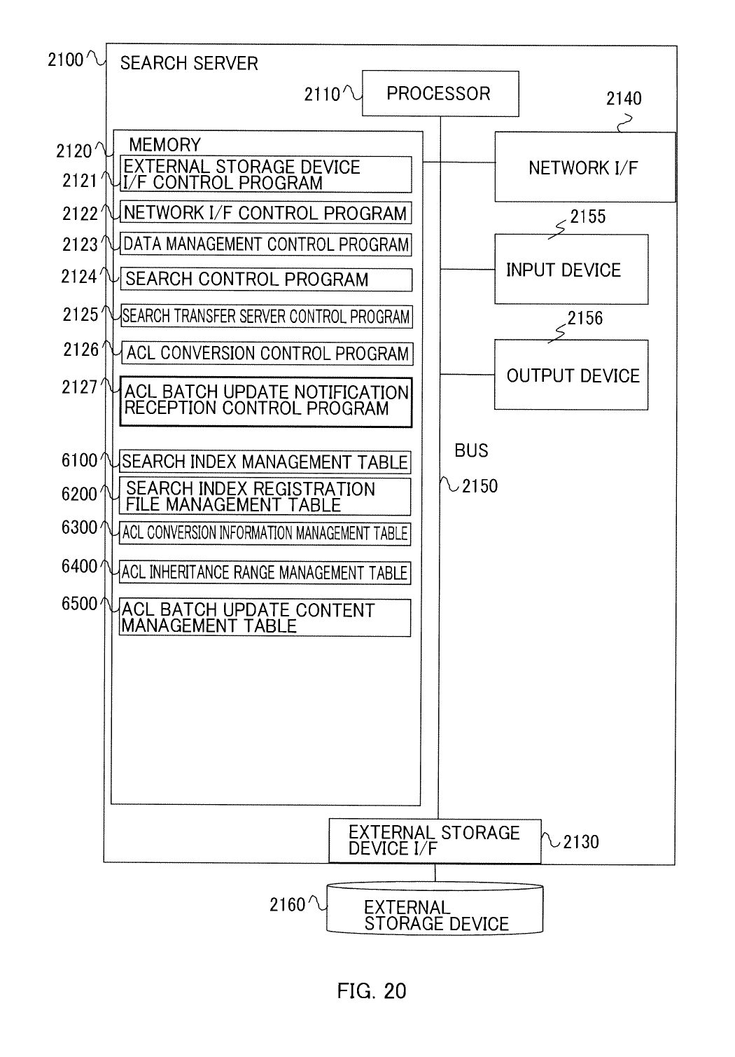

FIG. 20 shows contents of changes in the configuration in the illustration exemplifying the hardware configuration of the search server 2100 described in FIG. 5. In FIG. 20, another ACL batch update notification reception control program 2127 is added to the components in FIG. 5. Another ACL inheritance range management table 6400 and another ACL batch update content management table 6500 are added as management tables used for the batch update process. Other components are not changed. Description is given of the components newly added here.

The ACL batch update notification reception control program 2127 receives, in the search server 2100, the ACL batch update content which is notified from the document management server 1100 and registers the information on a management table to be described later. Thereafter, the update information is utilized to update a search index without the crawling of the file server 2100. This specific processing flow is described later.

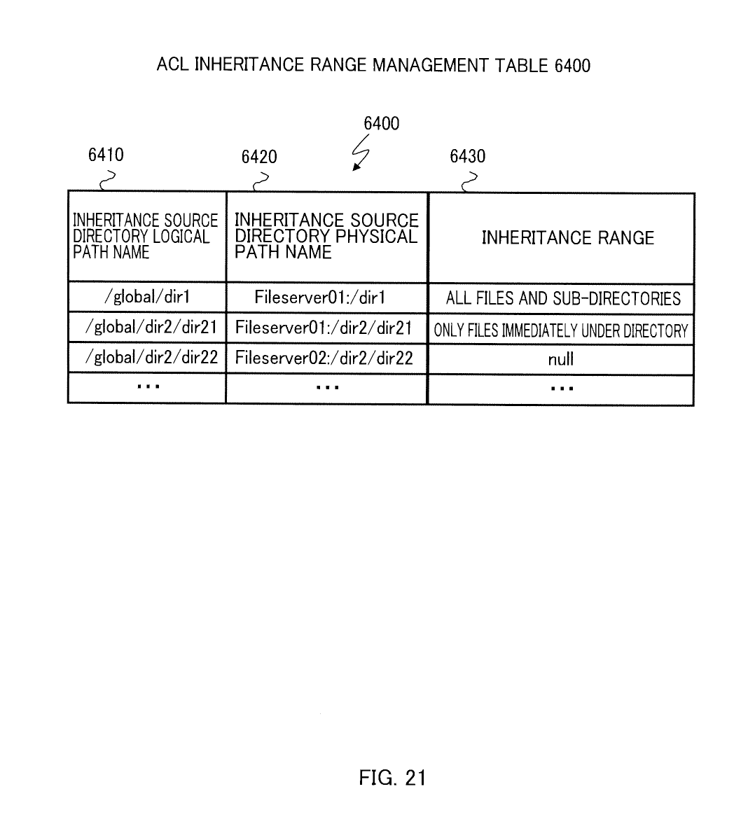

FIG. 21 is an illustration exemplifying the configuration of the ACL inheritance range management table 6400 which is managed on the search server 2100. The ACL inheritance range management table 6400 manages the setting information set by the document management server 1100 with regard to the ACL inheritance range utilizing the ACL inheritance function. The ACL inheritance range management table 6400 registers information based on the contents notified from the ACL batch update notification transmission control sub-program 1176 in the document management server 1100. Specifically, the ACL inheritance range management table 6400 includes configuration information such as an inheritance source directory logical path name 6410, an inheritance source directory physical path name 6420, and an inheritance range 6430.

The inheritance source directory logical path name 6410 registers path name information of a directory to be a base point for ACL batch update performed utilizing the ACL inheritance function. The path name registered here is a path name for accessing a target directory on the document management server 1100. The inheritance source directory physical path name 6420 registers path name information in the file server 3100 in which the directory to be a base point for the ACL batch update is actually stored. The path name registered here may be combined information of the identification information of the file server 3100 storing the target directory and a path name of the target directory. The inheritance range 6430 defines a range of the ACL information to be inherited and reflected by using the directory designated by the inheritance source directory logical path name 6410 as a base point. For example, as shown in FIG. 21, when “ALL FILES AND SUB-DIRECTORIES” is defined, ACL information is inherited to all files and sub-directories which are included in the directory to be a base point. When “ONLY FILES IMMEDIATELY UNDER DIRECTORY” is defined, ACL information is only inherited to files stored in the directory itself to be a base point. When “null” is defined, this means that there is no inheritance range. In the directory to be a base point for inheritance, this “null” is used when ACL information is individually set, in a case where ACL information is set to be inherited but all files and sub-directories under the directory do not accept the inheritance from an upper directory.

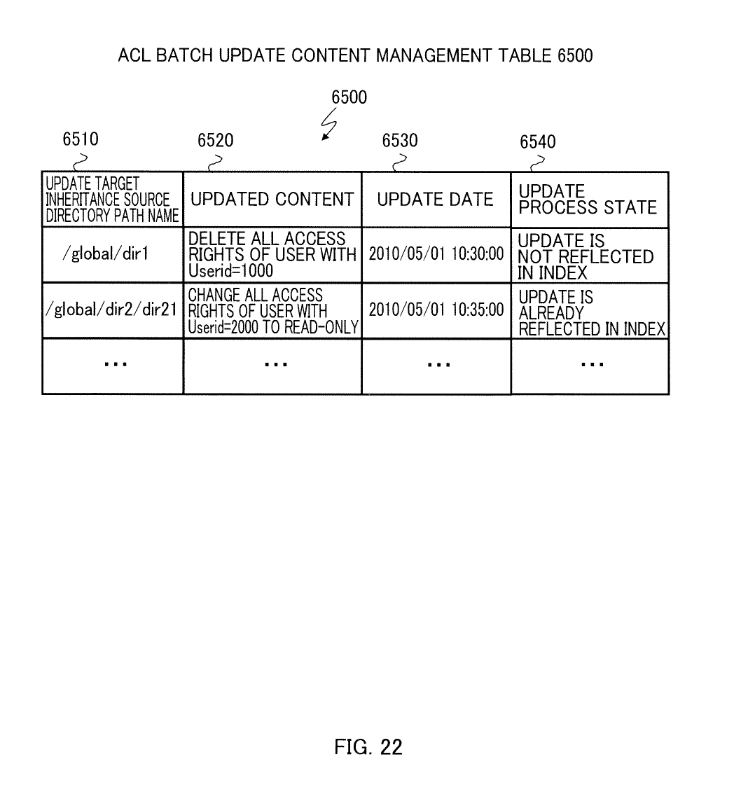

FIG. 22 is an illustration exemplifying the configuration of the ACL batch update content management table 6500 which is managed on the search server 2100. The ACL batch update content management table 6500 manages the setting information on the ACL batch update process performed by the document management server 1100 using the ACL inheritance function. This table registers information based on the contents notified from the ACL batch update notification transmission control sub-program 1176 in the document management server 1100. Specifically, the ACL batch update content management table 6500 includes configuration information such as an update target inheritance source directory path name 6510, an update content 6520, an update date 6530, and an update process state 6540.

The update target inheritance source directory path name 6510 registers path name information of a directory to be a base point in the ACL batch update process. The path name registered here is information same as that of the inheritance source directory logical path name 6410 described in FIG. 21. The update content 6520 registers information on the ACL update content in the ACL batch update process. For example, as shown in FIG. 22, if “DELETE ALL ACCESS RIGHTS OF USER WITH Userid=1000” is registered, the ACL information is updated so that the access permission operation of a user having Userid of 1000 is disabled with respect to all files and sub-directories in the ACL inheritance range. This Userid may be any format as long as it is information capable of identifying a target user. In addition, the update content 6520 may register any piece of information as long as it is information showing the update content of the ACL information. For example, the content of a command used for actually updating the ACL information may be registered. The update date 6530 registers information on a date when the ACL batch update request is made. The update process state 6540 registers information on a process state in the search server 2100 since the ACL batch update notification is received. For example, if “UPDATE IS NOT REFLECTED IN INDEX” is registered, it shows that the update process of the search index subjected to the ACL batch update process is not completed. Also, if “UPDATE IS ALREADY REFLECTED IN INDEX” is registered, it shows that the update process of the search index subjected to the ACL batch update process is completed.

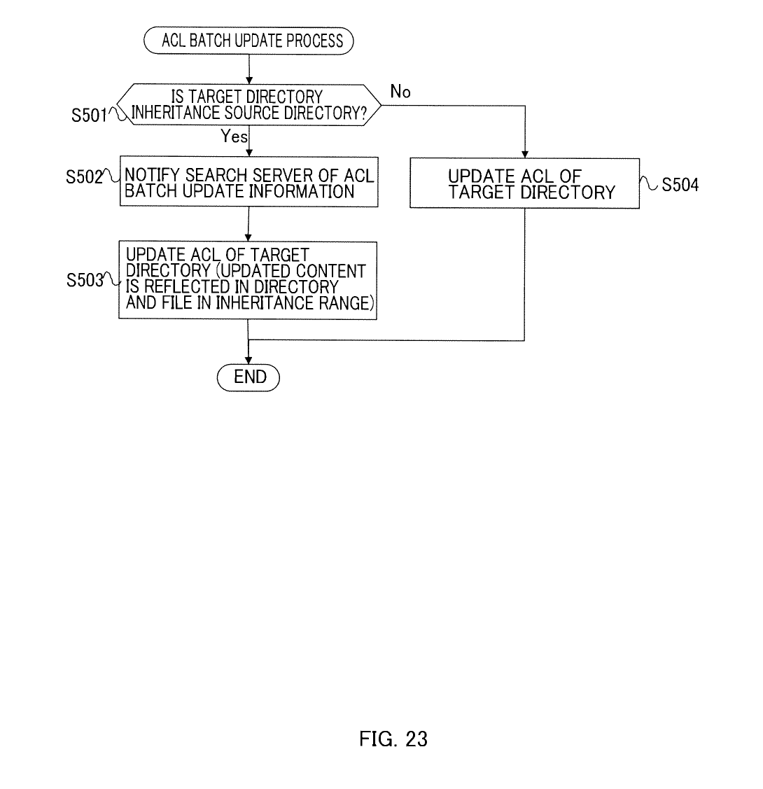

Based on the content of the changes in the configuration described above, the description is firstly given to the ACL batch update process in the document management server 1100. FIG. 23 shows a flow of the ACL batch update process in the document management server 1100. Firstly, the document management server 1100 checks if the ACL update target directory is an inheritance source directory of the ACL inheritance function (S501). The metadata of the target direction is referred here to check if the target directory is an inheritance source directory. If it is determined that the update target directory is not an inheritance source directory (No at step S501), the document management server 1100 updates the ACL of the target directory (S502) and the process is terminated. In this case, the update target directory does not need ACL inheritance. Thus, only a normal ACL update process is performed.

If it is determined that the update target directory is an inheritance source directory (Yes at step S501), the document management server 1100 notifies the search server 2100 of the ACL batch update information (S502). The ACL batch update notification transmission control sub-program 1176 in the document management server 1100 transmits the ACL batch update information to the search server 2100. A search server 2100 to which the ACL batch update information is transmitted may be determined by the following method. That is, the ACL batch update information is transmitted to all search servers 2100 to which the search transfer client control sub-program 1174 transfers a search request or the ACL batch update information is transmitted to a search server 2100 which is selected by refining from a group of the search servers 2100 receiving a search request and selecting a search server in which a file or directory targeted for ACL batch update is stored. The contents notified here are caused to include information which is recorded in the ACL inheritance range management table 6400 and the ACL batch update content management table 6500 shown in FIGS. 21 and 22. After notifying the ACL batch update information, the document management server 1100 updates the ACL information of the target direction stored therein (S503). The document management server 1100 causes the update contents to be transferred to and reflected not only in the ACL information of the update target directory but also in the directory and file included in the inheritance range using the directory as a base point.

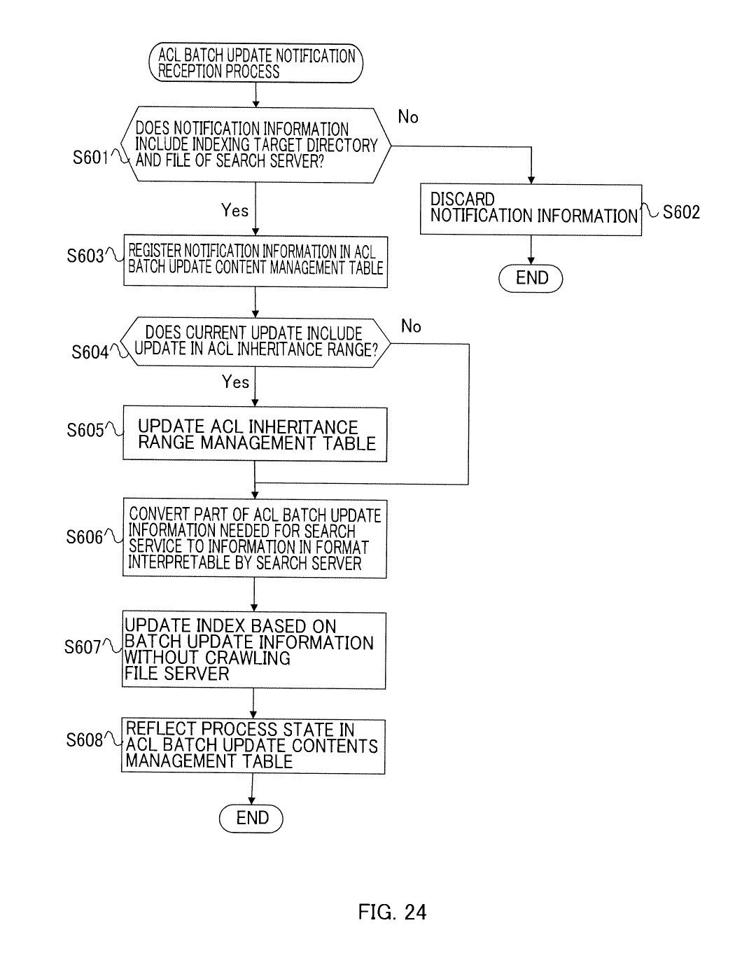

Hereinafter, description is given of the ACL batch update notification reception process in the search server 2100. FIG. 24 shows a flow of the ACL batch update notification reception process in the search server 2100. Firstly, it is checked in the search server 2100 whether or not the received ACL batch update notification information includes an indexing target directory or file of the search server 2100 (S601). It is only necessary to check whether or not a file or directory stored in the search server 2100 are included in the update target, based on the path name of the inheritance source directory included in the ACL batch update notification information and information in the inheritance range. If it is determined that the file or directory is not included in the indexing target (No at step S601), the search server 2100 discards the notification information (S602) and terminates the current process. In this case, the search server 2100 does not need to update the search index by the ACL batch update process. Thus there is no problem in discarding the notification information.

If it is determined that the directory or file is included in the indexing target (Yes at step S601), the search server 2100 registers the notification information in the ACL batch update content management table 6500 (S603). Here, information of “UPDATE IS NOT REFLECTED IN INDEX” is registered in the column of the update process state 6540. After that, the search server 2100 checks whether or not the current ACL batch update process includes the update of the ACL inheritance range (S604). It is checked here whether or not the information on the current ACL inheritance range included in the notification information includes a content changed from the content already registered in the ACL inheritance range management table 6400. If it is determined that the ACL inheritance range is not updated (No at step S604), the process moves to step S606 to be described later. If it is determined that the ACL inheritance range is updated (Yes at step S604), the search server 2100 updates the ACL inheritance range management table 6400 (S605). The changed content which is found through the process at step S604 is reflected in the ACL inheritance range management table 6400.

Then, the search server 2100 coverts part of the ACL batch update information registered in the ACL batch update content management table 6500, which is needed for the search service, to information in a format interpretable in the search server 2100 (S606). Here, the information needed for the search service is equivalent to the ACL information needed for performing the security trimming on the search result in the search server 2100. When the ACL information is converted to information in an interpretable format, the information registered in the ACL conversion information management table 6300 is utilized and then a process similar to that described in step S207 in FIG. 16 is performed. After that, the search server 2100 updates the search index based on the batch update information without the crawling of the file server 3100 (S607). The information targeted for index update is only the ACL information updated through the ACL batch update process. Utilizing this information as differential information for search index update, the search index in the search server 2100 is updated. Accordingly, the search server 2100 does not need to read a search target file from the file server 3100. Finally, the search server 2100 reflects the process state in the ACL batch update content management table 6500 (S608). If update is already reflected in the search index, the information of “UPDATE IS ALREADY COMPLETED” is registered in the column of the update process state 6540. If the update is being reflected in the search index, the information of “UPDATE IS BEING REFLECTED IN INDEX” may be registered, and if the process failed to be reflected during the process, the information of “UPDATE FAILED TO BE REFLECTED IN INDEX” may be registered. There is no problem to delete the entry of “UPDATE IS ALREADY REFLECTED IN INDEX” in the ACL batch update content management table 6500. Thus, the entry may be deleted from the table as needed.

With the processes described above, the ACL change content can be efficiently reflected in the search index through the ACL batch update process performed in the document management server 1100.

### Third Embodiment

The above-described first embodiment uses the mode where ACL information in a specific format set by the document management server 1100 is converted, when performing the index update process in the search server 2100 through the crawling process of the search target file, to information in a format interpretable by the search server 2100. However, the ACL conversion process may be performed in a process other than the crawling process. For example, it is also possible that the search server 2100 accesses the file server 3100 asynchronously with the crawling process, and converts the ACL information in a specific format which is set by the document management server 110 and is stored in the migration file to ACL information in a general format. In this case, the converted ACL information cannot be immediately reflected in the search index. Thus, the ACL information after conversion is adapted to be capable of being stored as metadata of the target file. Accordingly, the ACL information of the document management server 1100 can be reflected in the search index in the search server 2100 without changing the conventional search index update process. And now, the description is given of a control method as a third embodiment of implementing ACL conversion asynchronously with the search index update process.

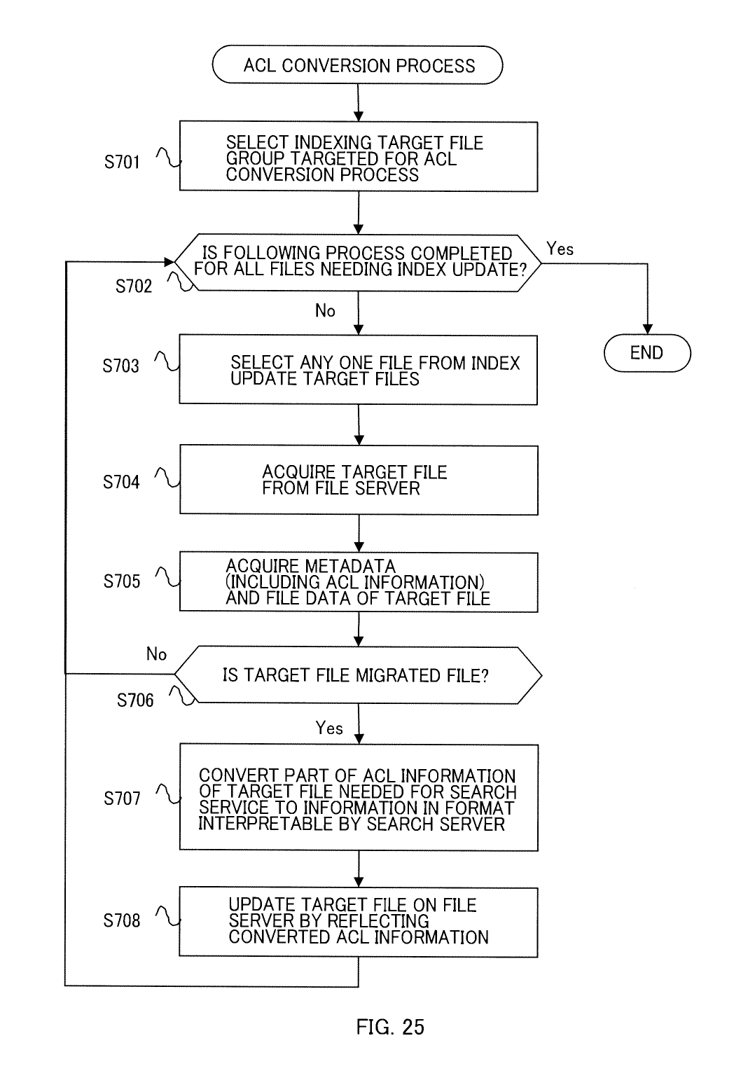

As described above, to implement the ACL conversion asynchronously with the search index update process, a new process to convert ACL has to be added. The added content is described by referring to FIG. 25.

FIG. 25 shows a flow of the ACL conversion process in the search server 2100. Firstly, the search server 2100 selects an indexing target file group targeted for the ACL conversion from the file group stored in the file server 3100 targeted for search (S701). The indexing target file group is selected by selecting a file included in the search range registered in the search server 2100 in advance. Then, the search server 2100 checks whether or not the ACL conversion process is performed for all the target files (S702). If it is determined that the ACL conversion is completed for all the files (Yes at step S702), the current process is terminated. If it is determined that the ACL conversion is not completed for all files (No at S702), the process to be described below is performed.

Thereafter, the search server 2100 selects anyone file from the index update target files (S703). Then, the search server 2100 acquires a target file from the file server 3100 (S704). Then, the search server 2100 acquires metadata (including ACL information) and target file data of the acquired target file (S705). After that, the search server 2100 checks based on the acquired information whether or not the target file is a migrated file (S706). This determination may be made by checking the metadata of the target file or based on information such as a format of the file data. If it is determined that the target file is not a migrated file (No at step S706), the process returns to step S702. If it is determined that the target file is a migrated file (Yes at step S706), the process proceeds to step S707.

Thereafter, the search server 2100 acquires ACL information of the target file in a specific format set by the document management server 1100 and converts part of the ACL information of the target file needed for the search service to information in a format interpretable by the search server 2100 (S707). The ACL conversion is performed here by the same process as that of step S207 in FIG. 16. Finally, the search server 2100 updates the metadata of the target file on the file server 3100 by designating the converted ACL information (S708). The converted ACL information is overwritten on the portion in the metadata of the target file in which the ACL information of the file server is registered. Accordingly, if the ACL information of the file is acquired and the index is updated based on the acquired information when the search server 2100 performs crawling of the file separately for index update, the security trimming can be performed on the search result based on the ACL information in a specific format set by the document management server 1100. After step S708 is completed, the process moves to step S702.

With the processes performed as described above, the ACL conversion process can be performed in the search server 2100 asynchronously with the indexing update process.

### Fourth Embodiment

The above-described first embodiment uses the mode where ACL information in a specific format set by the document management server 1100 is converted by the search server 2100 to ACL information in a format interpretable by the search server 2100. However, the ACL conversion process may be performed by a server other than the search server 2100. For example, the file server 3100 storing a migration file may perform the ACL conversion. It is adapted here that the ACL conversion process is performed when the file server 3100 receives a migration file from the document management server 1100 so as to reduce the processing load of the search server 2100. And now, description is given to a control method, as a fourth embodiment, to implement in the file server 3100 the migration file reception process in which ACL conversion is also performed.

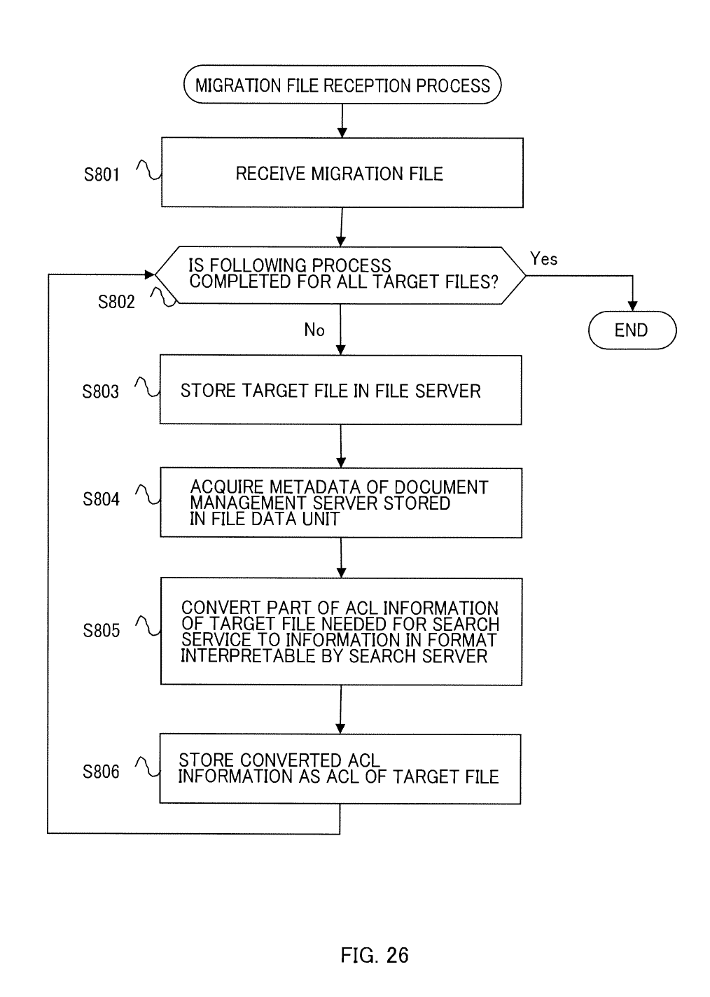

As described above, to implement the migration file reception process performing the ACL conversion in the file server 3100, a new ACL conversion information management table 6300 has to be added in the file server 3100 and then the migration file reception process performing the ACL conversion in the file server 3100 has to be executed again. The same ACL conversion information management table 6300 as that exemplified in FIG. 14 may be used, and description thereof is omitted here. Description is given here of portions of FIG. 26 different from those of FIG. 14.

FIG. 26 shows a flow of the migration file reception process in the file server 3100. Firstly, the file server 3100 receives a migration file which is transmitted from the document management server 1100 (S801). Then, the file server 3100 checks whether or not the following process is completed for all the target files (S802). If it is determined that the process is completed for all the files (Yes at step S802), the current process is terminated. If it is determined that the process is not completed for all the files (No at S802), the process to be described below is performed.

Then, the file server 3100 stores the received migration file therein (S803). After the target file is stored, information of a path name relating to the target file is returned to a request source of the migration process. Then, the file server 3100 acquires metadata 7010 of the document management server 1100, which is stored in the file data 8020 of the file (S804). Thereafter, the file server 3100 acquires ACL information of the target file in a specific format set by the document management server 1100 and converts part of the ACL information of the target file needed for the search service to information in a format interpretable by the search server 2100 (S805). The ACL conversion is performed here by the same process as that of step S207 in FIG. 16. Finally, the file server 3100 designates the converted ACL information and stores the converted ACL information as the ACL information of the target file on the file server 3100 (S806). The converted ACL information is overwritten on the portion in the metadata of the target file in which the ACL information of the file server 3100 is registered. Accordingly, if the ACL information of the file is acquired and the index is updated based on the acquired information when the search server 2100 performs a separate crawling process on the file for index update, the security trimming can be performed on the search result based on the ACL information in a specific format set by the document management server 1100. After step S806 is completed, the process moves to step S802.

With the processes performed as described above, the migration file reception process performing ACL conversion can be performed in the file server 3100. In this embodiment, description is given of the case where the ACL conversion is performed when the migration file is received. However, the ACL conversion may be performed in a different timing. For example, the ACL conversion may be performed asynchronously with the migration file reception process. Apart from that, the ACL conversion can be implemented through various possible embodiments.

### Fifth Embodiment

The above-described fourth embodiment uses the mode where ACL information in a specific format set by the document management server 1100 is converted by the file server 3100 to ACL information in a format interpretable by the search server 2100. However, the ACL conversion process may be performed by a server than the file server 3100. For example, the ACL conversion process may be performed by the document management server 1100. It is adapted here that the ACL conversion process is performed for the migration target file when the document management server 1100 causes a file to be migrated to the file server 3100 so as to reduce the processing load of the search server 2100. Now, description is given of a control method as a fifth embodiment to implement the migration process which also performs the ACL conversion in the document management server 1100.

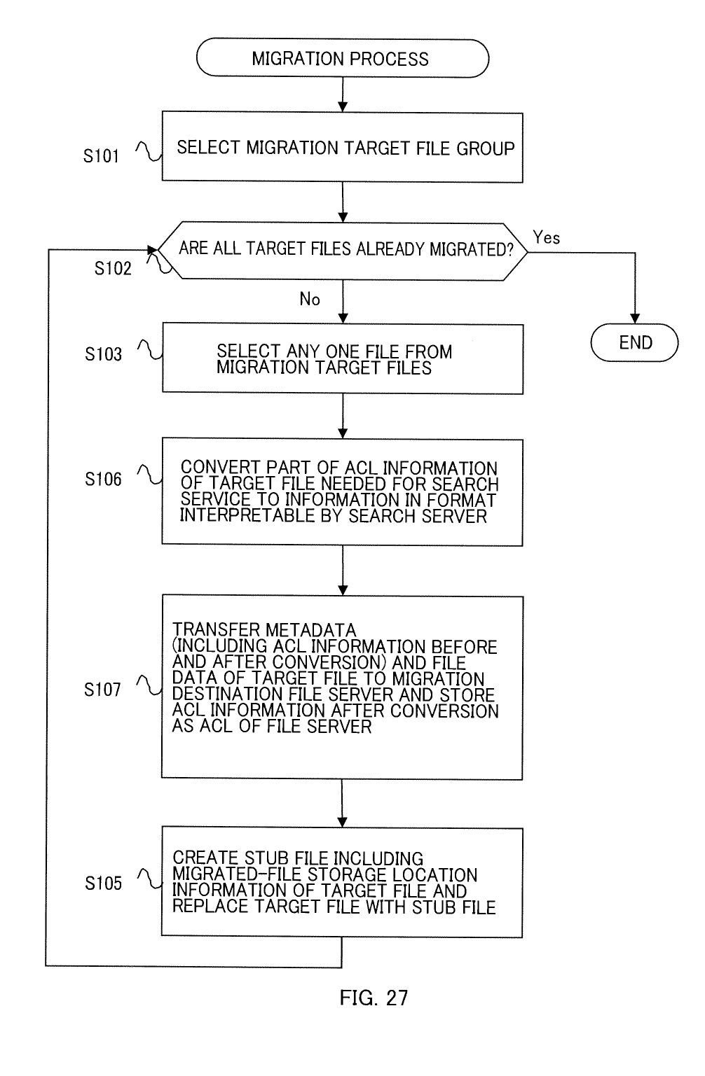

As described above, to implement the migration process performing the ACL conversion in the document management server 1100, a new ACL conversion information management table 6300 has to be added in the document management server 1100, and then the migration process performed by the document management server 1100 has to be changed so as to perform the ACL conversion. Here, the same ACL conversion information management table 6300 as that exemplified in FIG. 14 may be used, and thus description thereof is omitted here. Description is given here of portions of FIG. 27 different from those of FIG. 14.

FIG. 27 shows the contents of changing the migration process in the document management server 1100 described in FIG. 15. The current flow is different from that of the migration process described in FIG. 15 in that another process of transmitting the ACL information of the migration target file to a migration destination, together with the converted information in a format interpretable by the search server 2100 is performed. The specific description is as follows.

The flow in FIG. 27 is different from that in FIG. 15 in that the process at step S104 is replaced with steps S106 and S107. Apart from that, the flow exemplified in FIG. 27 is the same as that in FIG. 15. For simplicity, description is only given of updated portions.

After step S103 is completed, the document management server 1100 converts part of the ACL information of the migration target file needed for search service to information in a format interpretable by the search server 2100 (S106). The ACL conversion is performed here by the same process as that of step S207 in FIG. 16. It is assumed that the ACL information acquired from the migration target file is ACL information in a specific format set by the document management server 1100. Then, the document management server 1100 transfers the metadata (including ACL information before and after conversion) and file data of the target file to the migration destination file server 3100, and stores the ACL information after conversion as ACL of the file server 3100 (S107). Accordingly, if the ACL information of the file is acquired and the index is updated based on the acquired information, when the search server 2100 performs the crawling process on the file for index update, the security trimming can be performed on the search result based on the ACL information in a specific format set by the document management server 1100.

As shown in FIG. 11, the ACL information before conversion may be stored as part of the file data of the migration destination (as the ACL 7012 of the document management server 1100), and the ACL information after conversion may be stored as the ACL 8012 of the file server inside the file metadata of the migration destination. Different from FIG. 11, the ACL information before conversion may be stored as part of the file metadata 8010 in the migration destination.

With the processes performed as described above, the migration process performing ACL conversion can be performed in the document management server 1100. In this embodiment, description is given of the case where the ACL conversion is performed when the migration process is performed. However, the ACL conversion may be executed in a different timing. For example, the ACL conversion in the document management server 1100 can be performed asynchronously with the migration process. Apart from that, the ACL conversion can be implemented through various possible embodiments.

With the configuration as described above, the security trimming can be performed for the search result based on the ACL information in a specific format by the search server which can interpret the ACL information in a general format without missing the ACL information in a specific format whose setting granularity is finer. Accordingly, not only can the optimum allocation control be performed by causing file data to be migrated between computers, but also the security trimming can be performed by each search server 2100 for the search result according to ACL information in a specific format in the information processing system in which different access control modes are present. Thus, a secure integrated search service can be provided even under the environment in which the above-described different access control modes are present.

Moreover, when the ACL information in a specific format is converted to the ACL information in a general format, only the information used in the search function in the document management server 1100 is targeted for conversion. Targeted here are a right to refer (READ privilege) and a right to search (SEARCH privilege) with respect to the target information resource. These pieces of information are used for verifying whether or not a search user has a right to refer to or search for the information resource included in the search result at the time of the security trimming in the search server 2100. All the document management servers 1100 receive the access request for the information resource stored in the file server 3100, regardless of whether or not the target information resource is migrated. The document management server 1100 transfers the access request to the file server 3100 in a migration destination as needed and acquires the desired information resource. For this reason, the ACL information other than the read privilege and the search privilege is not needed in the search server 2100, and thus the ACL information does not need to be converted.

The present invention may be configured as a control system or a control method in addition to the above-described controller. Also, the present invention may be implemented in various modes such as a computer program achieving the above-described controller, recording medium recording the program, and a data signal which includes the program and is embodied on carrier waves.

Moreover, if the present invention is configured as a computer program or a recording medium recording the program, a controller or a program controlling the controller as a whole may be configured or only a part serving a function of the invention may be configured. As the recording medium, there can be used various volatile recording media and non-volatile recording media which are readable by a computer, such as a flexible disk, CD-ROM, DVD-ROM, punched card, printed matter on which a symbol such as a bar code is printed, and internal and external storage devices of a computer.

What is claimed is:

1. An information processing system which provides a file storage region for an external apparatus, comprising:
a first storage apparatus configured to control an access from the external apparatus to a stored file according to a first access control information format;
a second storage apparatus configured to control an access from the external apparatus to the stored file according to a second access control information format whose setting granularity is finer than that of the first access control information format used in the first storage apparatus;
a first search controller configured to search for the file stored in the first storage apparatus in response to a search request from the external apparatus and refine a search result by applying the first access control information format to the search result; and
a second search controller configured to search for the file stored in the second storage apparatus in response to a search request from the external apparatus and refine a search result by applying the second access control information format to the search result,
the first storage apparatus, the second storage apparatus, the first search controller, and the second search controller being coupled to one another, wherein
the second search controller receives the search request from the external apparatus, transfers the received search request to the first search controller, and integrates the search result by the first search controller and the search result by the second search controller together, and
if the file stored in the second storage apparatus is migrated to the first storage apparatus, the first search controller extracts, from first access control information based on the second access control information format set for the file, information which the first search controller is to use when creating a search index based on the migrated file, converts the extracted information to second access control information based on the first access control information format, and sets the second access control information as information on the file in a search index of the first search controller, and
the first search controller refines the search result based on the second access control information, when executing a search in response to the search request received from the second search controller.

2. The information processing system according to claim 1, wherein
if the first access control information is converted to the second access control information for a plurality of files migrated from the second storage apparatus to the first storage apparatus, the second storage apparatus notifies the first search controller of a migration source of each of the files migrated from the second storage apparatus to the first storage apparatus, a range of file storage location in which an update content is to be reflected if the migration source file is updated, and the update content,
the first search controller collectively updates information recorded in the search index according to the notified migration source of the file, the notified range of file storage location in which the update content is to be reflected if the migration source file is updated, and the notified update content,
the first access control information format and the second access control information format are an access control list format, and
additional access control information is set by using the second access control information, the additional access control information enabling the second storage apparatus to perform operations of file creation, file read, file update, and file deletion, the additional access control information enabling the first search controller to perform only an operation of file read and disabling the first search controller to perform any operation other than the operation of file read.

3. The information processing system according to claim 1, wherein
if the first access control information is converted to the second access control information for a plurality of files migrated from the second storage apparatus to the first storage apparatus, the second storage apparatus notifies the first search controller of a migration source of each of the files migrated from the second storage apparatus to the first storage apparatus, a range of file storage location in which an update content is to be reflected if the migration source file is updated, and the update content, and
the first search controller collectively updates information recorded in the search index according to the notified migration source of the file, the notified range of file storage location in which the update content is to be reflected if the migration source file is updated, and the notified update content.

4. The information processing system according to claim 1, wherein
information on the file stored in the first storage apparatus is acquired asynchronously with the file migration process from the second storage apparatus to the first storage apparatus, the first access control information based on the second access control information format set for the file by the second storage apparatus is acquired, information to be used by the first search controller is extracted from the acquired information, the extracted information is converted to the second access control information based on the first access control information format, and the converted information is reflected in the file migrated to and stored in the first storage apparatus.

5. The information processing system according to claim 1, wherein
the second storage apparatus acquires the first access control information based on the second access control information format for a migration target file to the first storage apparatus, extracts information to be used by the first search controller from the acquired information, converts the extracted information to the second access control information based on the first access control information format, and transfers the first access control information, the second access control information, and the information of the migration target file to the first storage apparatus.

6. The information processing system according to claim 1, wherein
the first storage apparatus acquires the first access control information based on the second access control information format for a file migrated from the second storage apparatus, extracts information to be used by the first search controller from the acquired information, converts the extracted information to the second access control information based on the first access control information format, and stores, in the second storage apparatus, the first access control information, the second access control information, and the information of the migrated file.

7. The information processing system according to claim 1, wherein the first access control information format and the second access control information format are an access control list format.

8. The information processing system according to claim 1, wherein
the first access control information format is a permission bit format designating a permission content for access to the file, and
the second access control information format is an access control list format.

9. The information processing system according to claim 1, wherein
additional access control information is set by using the second access control information, the additional access control information enabling the second storage apparatus to perform operations of file creation, file read, file update, and file deletion, the additional access control information enabling the first storage apparatus to perform an operation of file read while disabling the first storage apparatus to perform any operation other than the operation of file read.

10. A method of controlling an information processing system which provides a file storage region for an external apparatus, the information processing system including
a first storage apparatus configured to control an access from the external apparatus to a stored file according to a first access control information format;
a second storage apparatus configured to control an access from the external apparatus to the stored file according to a second access control information format whose setting granularity is finer than that of the first access control information format used in the first storage apparatus;
a first search controller configured to search for the file stored in the first storage apparatus in response to a search request from the external apparatus and refine a search result by applying the first access control information format to the search result; and
a second search controller configured to search for the file stored in the second storage apparatus in response to a search request from the external apparatus and refine a search result by applying the second access control information format to the search result,
the first storage apparatus, the second storage apparatus, the first search controller, and the second search controller being coupled to one another,
the method comprising,
by the second search controller, receiving the search request from the external apparatus, transferring the received search request to the first search controller, and integrating the search result by the first search controller and the search result by the second search controller together, and
if the file stored in the second storage apparatus is migrated to the first storage apparatus, by the first search controller, extracting, from first access control information based on the second access control information format set for the file, information which the first search controller is to use, when creating a search index based on the migrated file, converting the extracted information to second access control information based on the first access control information format, and setting the second access control information, as information on the file, in a search index of the first search controller, and
by the first search controller, refining the search result based on the second access control information, when the first search controller is executing search in response to the search request received from the second search controller.

11. The method of controlling an information processing system according to claim 10, wherein
if the first access control information is converted to the second access control information for a plurality of files migrated from the second storage apparatus to the first storage apparatus, the second storage apparatus notifies the first search controller of a migration source of each of the files migrated from the second storage apparatus to the first storage apparatus, a range of file storage location in which an update content is to be reflected if the migration source file is updated, and the update content, and
the first search controller collectively updates information recorded in the search index according to the notified migration source of the file, the notified range of file storage location in which the update content is to be reflected if the migration source file is updated, and the notified update content.

12. The method of controlling an information processing system according to claim 10, wherein
information on the file stored in the first storage apparatus is acquired asynchronously with the file migration process from the second storage apparatus to the first storage apparatus, the first access control information based on the second access control information format set for the file by the second storage apparatus is acquired, information to be used by the first search controller is extracted from the acquired information, the extracted information is converted to the second access control information based on the first access control information format, and the converted information is reflected in the file migrated to and stored in the first storage apparatus.

13. The method of controlling an information processing system according to claim 10, wherein
the second storage apparatus acquires the first access control information based on the second access control information format for a migration target file to the first storage apparatus, extracts information to be used by the first search controller from the acquired information, converts the extracted information to the second access control information based on the first access control information format, and transfers the first access control information, the second access control information, and the information of the migration target file to the first storage apparatus.

14. The information processing system controlling method according to claim 10, wherein
the first storage apparatus acquires the first access control information based on the second access control information format for a file migrated from the second storage apparatus, extracts information to be used by the first search controller from the acquired information, converts the extracted information to the second access control information based on the first access control information format, and stores, in the second storage apparatus, the first access control information, the second access control information, and the information of the migrated file.

15. The method of controlling an information processing system according to claim 10, wherein the first access control information format and the second access control information format are an access control list format.

16. A first search controller coupled to a first storage apparatus, a second storage apparatus, and a second search controller to provide a file storage region for an external apparatus, the first storage apparatus configured to control an access from the external apparatus to a stored file according to a first access control information format, the second storage apparatus configured to control an access from the external apparatus to the stored file according to a second access control information format whose setting granularity is finer than that of the first access control information format used in the first storage apparatus, the second search controller configured to search for the file stored in the second storage apparatus in response to a search request from the external apparatus and refine a search result by applying the second access control information format to the search result, the first search controller configured to search for the file stored in the first storage apparatus in response to a search request from the external apparatus and refine a search result by applying the first access control information format to the search result, wherein
if the file stored in the second storage apparatus is migrated to the first storage apparatus, the first search controller extracts, from first access control information based on the second access control information format set for the file, information which the first search controller is to use when creating a search index based on the migrated file, converts the extracted information to second access control information based on the first access control information format, and sets the second access control information, as information on the file in a search index of the first search controller, and
the first search controller refines the search result based on the second access control information, when executing search in response to the search request received from the second search controller.

17. The first search controller according to claim 16, wherein
when converting the first access control information to the second access control information for a plurality of files migrated from the second storage apparatus to the first storage apparatus, the first search controller receives, from the second storage apparatus, a migration source of each of the files migrated from the second storage apparatus to the first storage apparatus, a range of file storage location in which an update content is to be reflected if the migration source file is updated, and the update content, and
the first search controller collectively updates information recorded in the search index according to the received migration source of the file, the received range of file storage location in which the update content is to be reflected if the migration source file is updated, and the received update content, and
additional access control information is set therein by using the second access control information, the additional access control information enabling the first storage apparatus to perform an operation of file read while disabling the first storage apparatus to perform any operation other than the operation of file read.

18. The first search controller according to claim 16, wherein
when converting the first access control information to the second access control information for a plurality of files migrated from the second storage apparatus to the first storage apparatus, the first search controller receives, from the second storage apparatus, a migration source of each of the files migrated from the second storage apparatus to the first storage apparatus, a range of file storage location in which an update content is to be reflected if the migration source file is updated, and the update content, and
the first search controller collectively updates information recorded in the search index according to the received migration source of the file, the received range of file storage location in which the update content is to be reflected if the migration source file is updated, and the received update content.

19. The first search controller according to claim 16, wherein
the first search controller acquires information on the file stored in the first storage apparatus asynchronously with the file migration process from the second storage apparatus to the first storage apparatus, acquires the first access control information based on the second access control information format set for the file by the second storage apparatus, extracts information to be used by the first search controller from the acquired information, converts the extracted information to the second access control information based on the first access control information format, and reflects the converted information in the file migrated to and stored in the first storage apparatus.
